(19) United States
(12) Patent Application Publication
(10) Pub. No.: US 2018/0094652 A1
(43) Pub. Date: Apr. 5, 2018

(54) PISTON LINKAGE AND AXLE DRIVE ASSEMBLY

(71) Applicant: QUALITY MANUFACTURING INC., Winchester, KY (US)

(72) Inventors: Jeffrey A. ROSE, Lexington, KY (US); James Adam ROSE, Lexington, KY (US)

(21) Appl. No.: 15/821,501

(22) Filed: Nov. 22, 2017

Related U.S. Application Data
(63) Continuation-in-part of application No. 15/235,923, filed on Aug. 12, 2016.
(60) Provisional application No. 62/208,250, filed on Aug. 21, 2015.
(60) Provisional application No. 62/426,048, filed on Nov. 23, 2016.
(60) Provisional application No. 62/463,443, filed on Feb. 24, 2017.
(60) Provisional application No. 62/473,801, filed on Mar. 20, 2017.
(60) Provisional application No. 62/491,838, filed on Apr. 28, 2017.

(51) Int. Cl. F15B 15/12; F15B 11/16; B25J 9/14

(52) U.S. Cl. CPC F15B 15/125; F15B 11/16; F15B 2211/7107; F15B 2211/7058; B25J 9/146

(57) ABSTRACT

A dual directional actuator may be linked to another actuator, device, object, or joint (e.g., a robotic limb or the like). A linkage mechanism may securely couple the actuator to the other actuator, device, object, or joint. Additionally, a piston axle bridge may couple the piston of the actuator to an internal or external axle. The dual directional actuator may be coupled to manifolds with integrated tee fittings to eliminate hoses external to a joint comprising one or more dual directional actuators.

### RELATED APPLICATIONS

This application is a continuation in part of U.S. patent application Ser. No. 15/235,923, filed Aug. 12, 2016, and titled “DEVICES AND SYSTEMS FOR PRODUCING ROTATIONAL ACTUATION,” which claims priority to U.S. Provisional Patent Application 62/208,250, filed Aug. 21, 2015, and titled “DEVICES AND SYSTEMS FOR PRODUCING ROTATIONAL ACTUATION,” the entire disclosure of which is hereby incorporated herein by this reference.

This application claims the benefit of U.S. Provisional Patent Application 62/426,048, filed Nov. 23, 2016, and titled “PISTON LINKAGE AND AXLE DRIVE ASSEMBLY,” and U.S. Provisional Patent Application 62/463,443, filed Feb. 24, 2017, and titled “PISTON LINKAGE AND AXLE DRIVE ASSEMBLY,” and U.S. Provisional Patent Application 62/473,801, filed Mar. 20, 3017, and titled “EXTERNAL AXLE,” and U.S. Provisional Patent Application 62/491,838, filed Apr. 28, 2017, and titled “AXLE LINKAGE AND DRIVE METHODS.” The entire disclosure of each listed application is hereby incorporated herein by this reference.

### TECHNICAL FIELD

This disclosure relates to devices and systems for producing rotational actuation. More particularly, this disclosure relates to actuators for producing and controlling rotational motion.

### BRIEF DESCRIPTION OF THE DRAWINGS

Non-limiting and non-exhaustive embodiments of the disclosure are described, including various embodiments of the disclosure with reference to the figures, in which:

FIG. 1 is a perspective view of a dual actuator comprising a pair of actuators, according to one embodiment.

FIG. 2 illustrates an exploded view demonstrating the placement of a dual actuator within a half joint housing.

FIG. 3 illustrates a portion of an actuator assembly as a full assembly, as an assembly with a housing removed, and as an assembly with the housing, endcaps, and o-rings removed.

FIG. 4 illustrates a planar cutaway view of an example of the actuator assembly of FIG. 3.

FIG. 5 illustrates an exploded view of the actuator assembly of FIG. 3 bolted to a half joint housing.

FIG. 6 illustrates a perspective view of a weld base 600 to which actuator cylinders may be brazed.

FIG. 7 is a simplified exploded view of a portion of a hydraulic joint using the weld base of FIG. 6.

FIG. 8 illustrates an axle assembly with an encoder shaft, bearings, and piston-axle linkage.

FIG. 9 illustrates a perspective view of a joint housing encompassing the axle assembly of FIG. 8 and an actuator housing or weld base.

FIG. 10 illustrates a planar view of the front side of a hydraulic rotary joint comprising an external axle.

FIG. 11 illustrates a planar view of the front side of the hydraulic rotary joint of FIG. 10 comprising an external axle.

FIG. 12 illustrates a front exploded view of a hydraulic rotary joint with link plates.

FIG. 13 illustrates a back exploded view of the hydraulic rotary joint of FIG. 12 with link plates.

FIG. 14 illustrates a perspective view of a ball joint actuator comprising three hydraulic rotary joints with external axles and link plates.

FIG. 15A illustrates a robotic hand utilizing hydraulic rotary joints with external axles in a posture for grasping with a 28 inch span.

FIG. 15B illustrates a robotic hand utilizing hydraulic rotary joints with external axles in a posture for grasping with a 21 inch span.

FIG. 15C illustrates a robotic hand utilizing hydraulic rotary joints with external axles in a posture for grasping with a 14 inch span.

FIG. 15D illustrates a robotic hand utilizing hydraulic rotary joints with external axles in a posture for grasping with a 7 inch span.

FIG. 16A illustrates a perspective view of a hydraulic rotary actuator with an external axle and internal piston axle linkage.

FIG. 16B illustrates a perspective view of a hydraulic rotary actuator with an external axle and internal piston axle linkage with manifolds.

FIG. 17 illustrates an interior perspective view of a stacked hydraulic rotary actuator with connecting plate.

FIG. 18A illustrates a side view of the stacked hydraulic rotary actuator with connecting plate.

FIG. 18B illustrates a side view of the stacked hydraulic rotary actuator with connecting plate with straight tubes connecting ports together.

FIG. 19 illustrates a perspective view of a stacked hydraulic rotary actuator with connecting plate.

FIG. 20 illustrates an embodiment of a stacked hydraulic rotary actuator with an internal axle.

FIG. 21 illustrates a perspective view of a joint-manifold assembly with internal flow paths.

FIG. 22 illustrates a perspective view of a first manifold half with internal flow paths.

FIG. 23 illustrates a perspective view of a second manifold half with internal flow paths.

FIG. 24 illustrates the placement of the first manifold half in the joint-manifold assembly.

FIG. 25 illustrates the placement of the second manifold half in the joint-manifold assembly.

FIG. 26 illustrates a perspective view of an actuator with a static seal between the endcap and a cylinder, and a dynamic seal between the endcap and a piston rod.

FIG. 27 illustrates the actuator of FIG. 26 with the cylinder exposed.

FIG. 28 illustrates an endcap with a static seal and dynamic seal integrated into the endcap.

FIG. 29 illustrates a side exploded view of an endcap.

FIG. 30 illustrates a perspective view of a dual directional actuator with fluid ports and endcaps, with integrated seals.

FIG. 31 illustrates a hydraulic rotary joint with a fluid series control circuit.

FIG. 32 illustrates a hydraulic rotary joint with a parallel fluid control circuit.

FIG. 33 illustrates a hydraulic circuit that enables electronically switching between parallel and series fluidly connected actuators.

### DETAILED DESCRIPTION OF PREFERRED EMBODIMENTS

The embodiments of dual directional actuators (e.g., hydraulic rotary actuators) described herein may include a toroidal actuation chamber formed by at least one actuation cylinder. Coupled pistons may be disposed in the actuation chamber. A fluid media (e.g., hydraulic fluid or air) may flow into the actuation cylinders and may cause operation of the dual directional actuator. Further, certain embodiments may include coupling a plurality of dual directional actuators together to increase an effective rotational range of the coupled actuators or to increase the torque of rotational actuation.

In some dual directional actuators, a coupling pin may be coupled to the pistons to enable a transfer of rotational power from an actuator to another actuator, device, object, or joint (e.g., a robotic limb or the like). However, the coupling pin may be prone to break due to rotational stresses, and when the coupling pin breaks, the transfer of rotational power ceases. A broken coupling pin would require repair or replacement to restore the functionality of the dual directional actuator.

Embodiments herein describe strengthened linkage mechanisms that may transfer rotational power more securely than a conventional coupling pin. The linkage mechanisms may couple the pistons to an axle to cause rotary motion of the axle which may securely transfer the rotational energy to another actuator, device, object, or joint. As described in more detail below, the axle may be central to or outside of the dual directional actuator.

The embodiments of the disclosure will be best understood by reference to the drawings, wherein like parts are designated by like numerals throughout. Components of the disclosed embodiments, as generally described and illustrated in the figures herein, could be arranged and designed in a wide variety of different configurations. Thus, the following detailed description of the embodiments of the systems and methods of the disclosure is not intended to limit the scope of the disclosure, as claimed, but is merely representative of possible embodiments of the disclosure. In addition, the steps of a method do not necessarily need to be executed in any specific order, or even sequentially, nor need the steps be executed only once, unless otherwise specified.

In some cases, well-known features, structures, or operations are not shown or described in detail. Furthermore, the described features, structures, or operations may be combined in any suitable manner in one or more embodiments. It will also be readily understood that the components of the embodiments as generally described and illustrated in the figures herein could be arranged and designed in a wide variety of different configurations.

While specific embodiments and applications of the disclosure have been illustrated and described, it is to be understood that the disclosure is not limited to the precise configuration and components disclosed herein. Various modifications, changes, and variations apparent to those of skill in the art may be made in the arrangement, operation, and details of the methods and systems of the disclosure without departing from the spirit and scope of the disclosure.

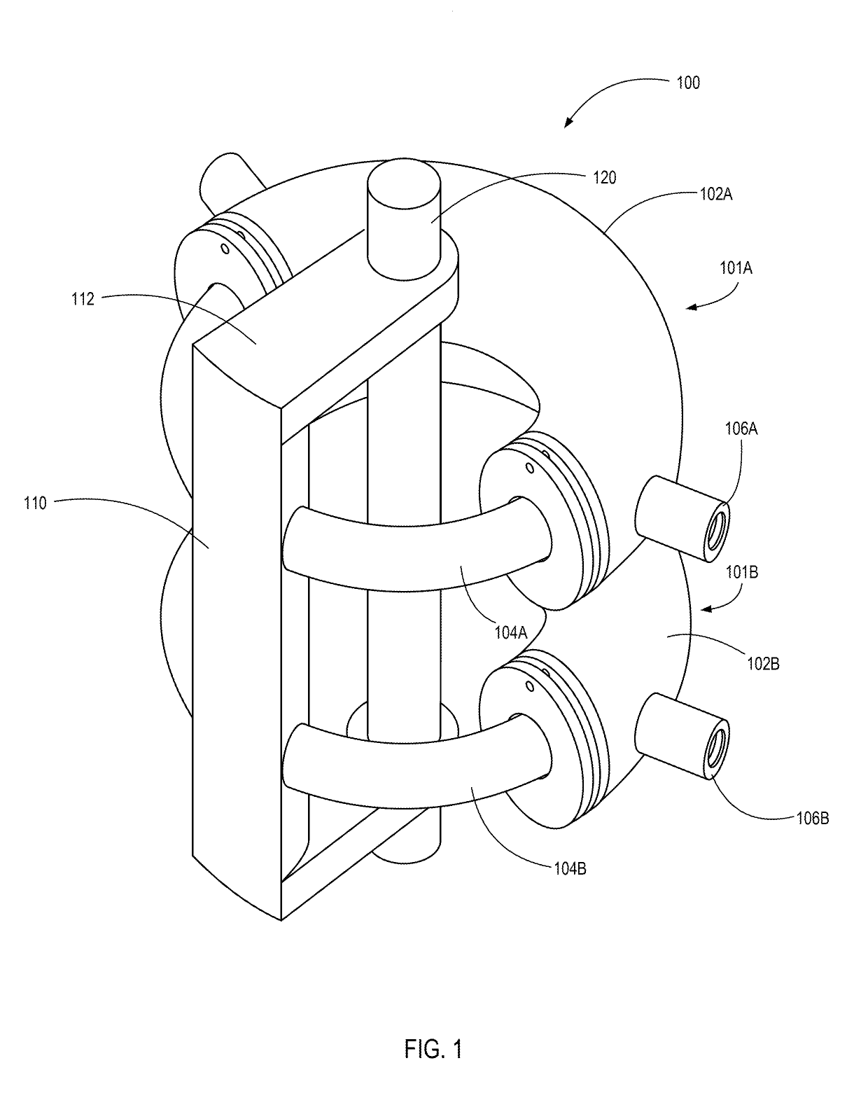

FIG. 1 is a perspective view of a dual actuator 100 comprising a pair of actuators 101A, 101B, according to one embodiment. The actuators 101A, 101B include cylinders 102A, 102B, pistons 104A, 104B, and fluid ports 106A, 106B. A piston linkage assembly 110 couples the pistons 104A, 104B to form a closed piston loop. A piston-axle bridge 112 may couple the piston linkage assembly 110 to an axle 120. For simplicity, housing is not shown in FIG. 1.

In this embodiment, the pistons 104A, 104B drive the axle 120 in the center of the actuators 101A, 101B to cause rotary motion of the axle 120. A fluid media (e.g., hydraulic fluid or air) may flow into the cylinders 102A, 102B via the fluid ports 106A, 106B and cause the pistons 104A, 104B to change position. The change in piston position results in movement of the piston linkage assembly 110. The rotary motion of the axle 120 is accomplished by permanently affixing the axle 120 to the piston linkage assembly 110. As illustrated in FIG. 1, the movement of the piston linkage assembly 110 may be transferred or translated into rotational movement of the axle 120 via the piston-axle bridge 112. Thus, introducing fluid media causes a rotational movement output of the actuators 101A, 101B. In some embodiments, the piston-axle bridge 112 may be on both sides of each actuator or piston 104A and 104B for more stability.

In some embodiments, the axle 120, the pistons 104A, 104B, the piston linkage assembly 110 and the piston axle bridge 112 may be fixedly attached to each other. For example, weld joints may couple each individual piece. In other embodiments, the axle 120, the piston linkage assembly 110 and the piston axle bridge 112 may be coupled via fasteners.

In some embodiments, the piston linkage assembly 110 and the piston axle bridge 112 may be a unified structure without joints. For example, the piston linkage assembly 110 and piston axle bridge 112 may be etched from a single block of material, or molded in one cast. This may increase the strength of the linkage-bridge assembly (e.g., the piston linkage assembly 110 and the piston axle bridge 112 combined). The additional strength may reduce the wear from the transfer of rotational force.

Additionally, in some embodiments, the axle 120 may also be machined, formed, or molded into a unified assembly with the piston linkage assembly 110 and the piston axle bridge 112. Thus, the axle 120, the piston linkage assembly 110, and the piston axle bridge 112 may be a single piece. The single piece design may reduce joint wear that may be associated with a joined axle 120, piston linkage assembly 110, and piston axle bridge 112.

Two or more actuators may be coupled together by the piston linkage assembly 110 connected to each of the pistons to form a single actuator. As shown, two or more coupled actuators 101A, 101B may operate in a same direction for a parallel connection (e.g., increasing torque). An actuation force is applied from one of the actuators 101A, 101B to the other of the actuators 101A, 101B by the piston linkage assembly 110, both of which connect to each side of the pistons 104A, 104B.

The piston linkage assembly 110 may be a single block of material that connects each side of the pistons 104A, 104B together, and operably couples the pistons 104A, 104B together. For example, a single block of material may include four mating mechanisms that align with pistons 104A, 104B. In some embodiments, the mating mechanisms may include a threaded hole, a groove, an aperture, or a tapered entry, and the ends of the pistons 104A, 104B may include a counterpart structure such as a screw, a tongue, or a peg that securely couples with the mating mechanism. In some embodiments, the pistons 104A, 104B remain in place in the mating mechanisms due to tension or friction.

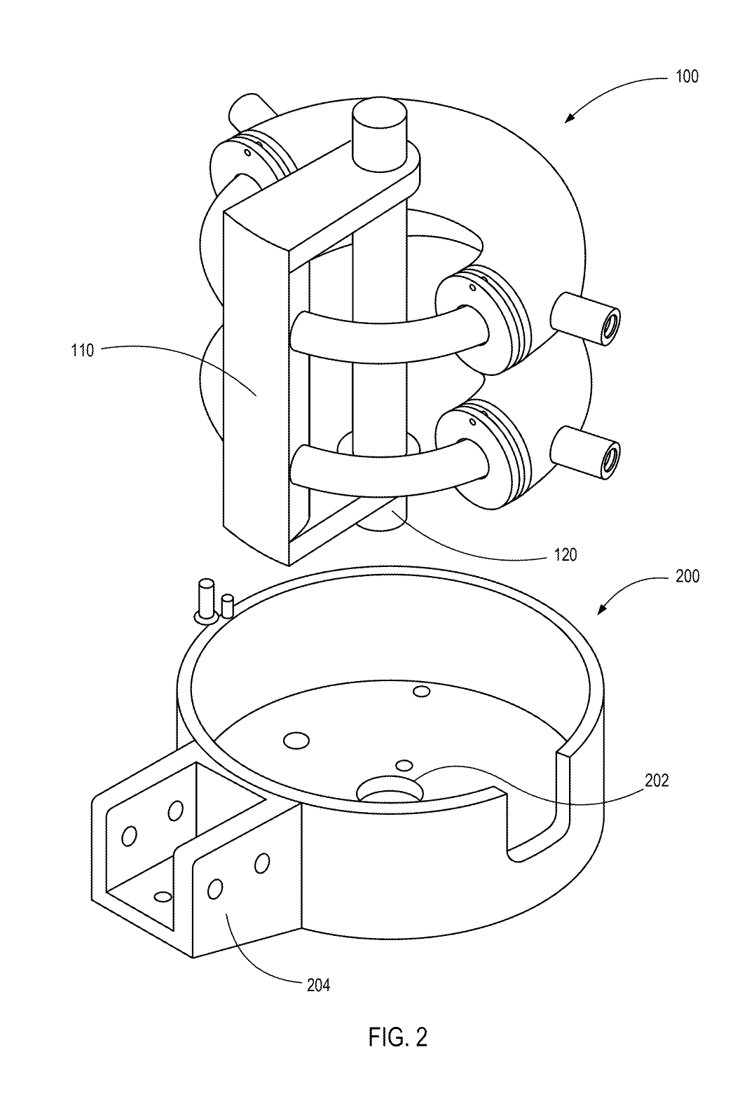

FIG. 2 illustrates an exploded view demonstrating the placement of a dual actuator 100 within a half joint housing 200. A second half joint housing may be coupled to the upper actuator half forming a complete joint housing. However, for simplicity, only the half joint housing 200 is shown in FIG. 2. As shown, the axle may be placed within an aperture 202 of the joint housing 200. The cylinder or axle may be coupled to the joint housing 200. The rotation of the axle 120 may cause the half joint housing 200 to rotate, thereby facilitating movement of a link coupled to the link bracket 204.

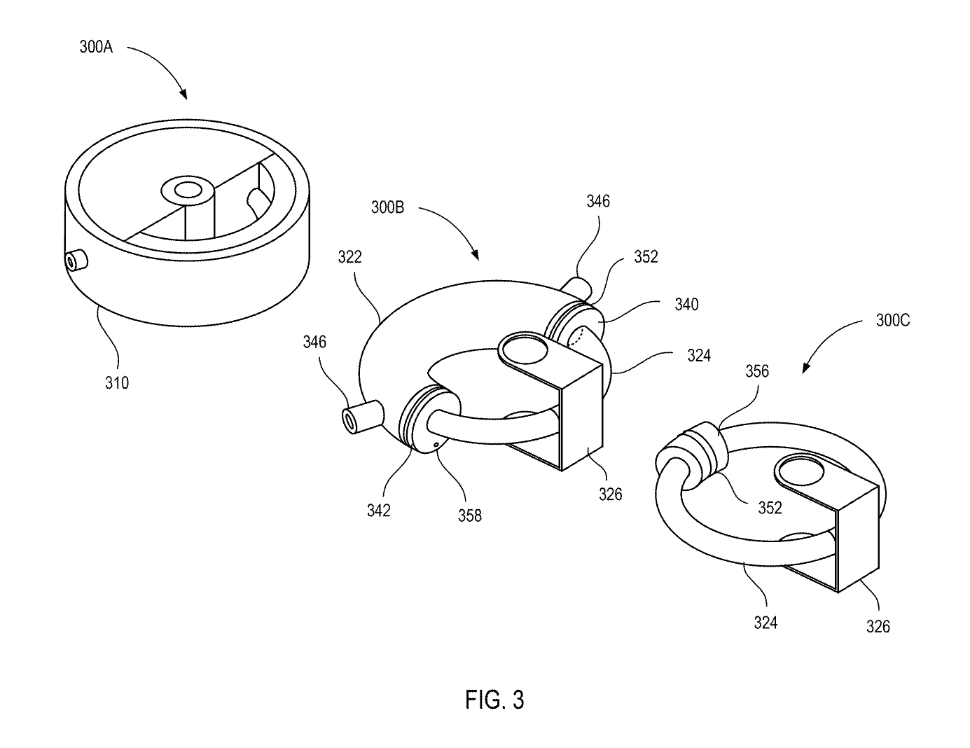

FIG. 3 illustrates a portion of a rotating actuator 300 as a full assembly 300A, as an assembly 300B with a housing 310 removed, and as a piston assembly 300C with the housing 310, endcaps 340, cylinder 322, and o-rings 352 removed. The embodiment in FIG. 3 is shown as a single actuator assembly; however, the dual actuator 100 of FIG. 1 may be similarly housed and constructed. Further, the dual actuator 100 may include a single housing or a separate housing for each actuator 101A, 101B.

The piston assembly 300C illustrates a piston 356 including an o-ring 352. In the embodiment of FIG. 3, piston 356 is a single molded piece with bearings molded into the piston (not shown) on both sides of a piston seal groove. In some embodiments, the piston seal 352 may be added after the molding and before insertion into molded cylinders 322. The torus shaped cylinder 322 may include a solid rod or tube of PEEK material, which is machined to tolerance and thermoformed into the torus cylinder 322. Other methods of making the torus cylinder may include hydroforming aluminum or gas assist blow molding.

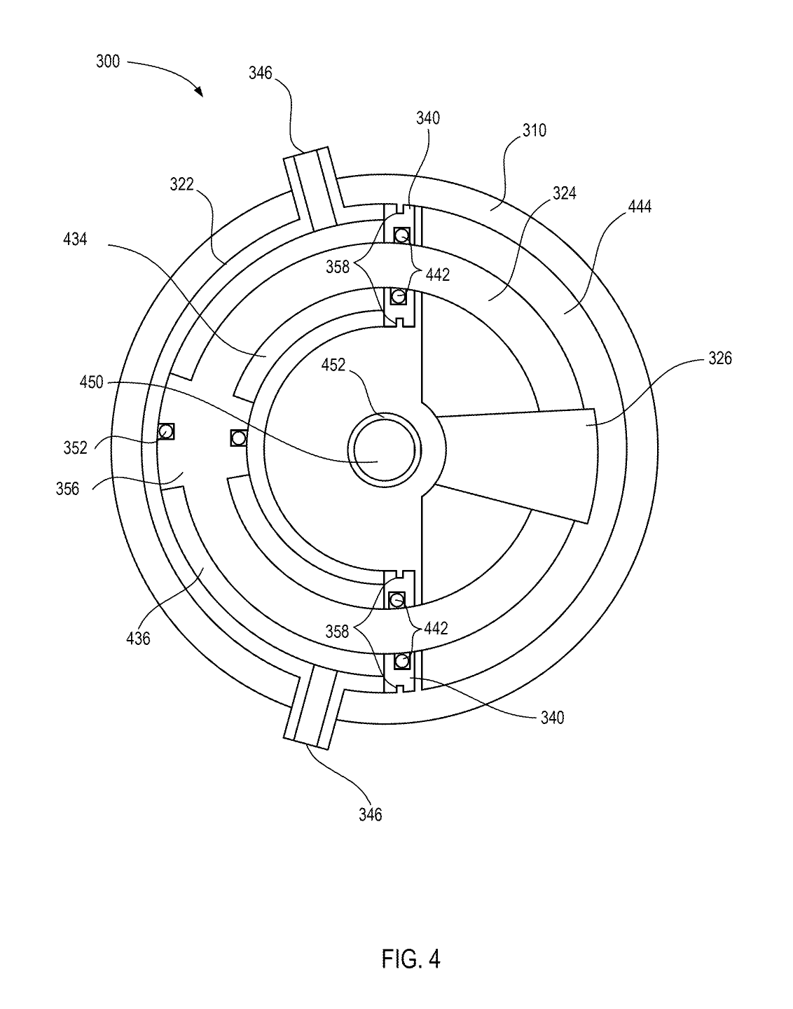

The piston 356 and piston rods 324 may be made into 3 separate pieces being 2 piston rods and a single piston, or piston 356 and 324 make be made into a single piece. Once the torus cylinder 322 is shaped, the one piece molded piston 356 and piston rod 324 is inserted into the torus cylinder 322. Next, 300B illustrates the molded endcaps 340 with inserted static o-ring seals 342 are slid over the piston rod into contact with the cylinder 322, which effectively seals the endcap and cylinder. A dynamic seal (e.g., seals 442 of FIG. 4) is placed inside a rod seal groove inside the endcap 340 to seal fluid between the endcap and piston rod. To effectively seal the high pressure hydraulic fluid the end cap uses a static seal between the endcap and cylinder and a second dynamic piston rod seal between the endcap and piston rod. In some embodiments, the cylinder 322 may have a 15-30 degree lead in a chamfer to prevent seal damage upon insertion of the piston assembly 324. A matching 15-30 degree angle on the endcaps 340 presses into the 30 degree lead in chamfer of the cylinder 322. The endcaps 340 may also have an alignment tongue and groove, since a through hole inside the endcaps 340 will have a radius that matches the radius of the piston rod 324 assembly. This alignment groove will ensure that the angle of the cylinder 322 is continued through the endcaps 340 so that the piston rod 324 will experience the same radius throughout its rotation.

Once the cylinder 322, seals 352, o-ring seals 342, piston 356 and rod 324, endcaps 340 and rod connector are assembled, this complete actuator assembly 300B may be used as an insert for a housing 310 injection molding operation (e.g., an encasement molding). The housing 310 may be molded around the actuator 300B in order to complete the housing 310. The housing 310 is further used to maintain the endcaps 340 in the correct position with the torus cylinder 322. A notch 358 is provided in the endcaps 340 so that the high strength plastic housing 310 may act as a pressure containment vessel to ensure the endcap 340 and cylinder 322 maintain integrity while pressurized. The full assembly 300B is inserted into the housing 310. The rotating actuator 300 shown in FIG. 3 may function as a joint half.

FIG. 4 illustrates a planar cutaway view of the rotating actuator 300 of FIG. 3, according to some embodiments. The rotating actuator 300 includes a continuous toroidal piston rod 324 that extends from an extension chamber 434 into a retraction chamber 436 (e.g., defined by a housing 310) of a toroidal cylinder 322. A linkage mechanism 326 for the piston rod 324 functions as a piston rod connector which secures both ends of the piston rod 324 together. The linkage mechanism 326 couples the piston rod 324 to an axle 450 and transfers the rotational movement of the piston rod 324 to the axle 450. The axle 450 may apply torque for joint actuation between the actuators or housing 310. The piston rod 324 connects to both sides of a piston. The cylinder 322 can be made from tubes of PEEK formed (e.g., thermoformed) into the shape of a torus cylinder. The piston rod 324 and piston assembly can be made from molded PEEK material or aluminum for example. The piston's face of each chamber can be connected by a linkage mechanism 326 attached to each side of piston rod 324.

In some embodiments, the linkage mechanism 326 or axle 450 connects the actuating torus cylinder 322 to additional torus cylinders to provide more rotation or torque. In some embodiments, the axle 450 connects the actuator to a second half of a rotating joint, when only a single actuator inside the rotating actuator 300 is used. The linkage mechanism 326 is perpendicular to the direction of rotation and parallel to the axis of rotation. The axle 450 may be the applicator of the joint torque between the actuators. Accordingly, an actuator is connected to each housing 310, and the actuators are connected together by the axle 450. The housing 310 is free to rotate on the axle 450 as the piston moves via bearings 452 mounted between the housing and the axle 450.

The toroidal cylinder 322 includes endcaps 340, which include piston rod seals 342 (or 442) configured to prevent fluid leaking out of the cylinder 322 in order to maintain pressure. Additional seals may be added between the endcap 340 and the cylinder 322 to prevent leakage between the endcap and the housing 310. A piston rod bearing 444 external to the cylinder, made from material such as PEEK, is used to support the piston rod 324 outside of the toroidal cylinder 322. Additional bearings can be molded into the piston 356 and endcaps 340 to further support the piston rod 324 and to reduce the force on the seals 442 and 352. Adding bearings on the piston 356 and endcaps 340 on each side of a seals 352 and 442 is commonly employed to increase seal life. Here a difference may be that the piston 356, piston rod 324, and wear rings are all molded together as a single unit. The external rod bearing 444 prevents bending of the piston due to side loading from rotational torque forces. The piston rod bearing 444 may be on both sides of the piston rod 324, even though the piston rod bearing 444 is only illustrated on one side of the piston rod 324.

The torus cylinder 322 includes ports 346 used for actuation, the cylinder, endcaps 340, bearing 444, the piston 356, and piston rod 324. The actuator is molded into a containment encasement 310, which locks the endcaps 340 into position relative to the cylinder 322. The encasement 310 may not make contact with the piston rod 324 in order to eliminate friction between the encasement 310 and piston rod 324. The endcap 340 and cylinder 322 may have matching tongue and groove fittings to keep the endcap 340 and cylinder 322 in alignment. A through-hole of the endcap 340 for receiving the piston rod 324 may match the radius of the piston rod 324 to ensure a leak-free fit. While FIG. 3 illustrates the ports 346 in the side of the cylinder 322, the ports 346 may also be through the endcaps 340 in some embodiments.

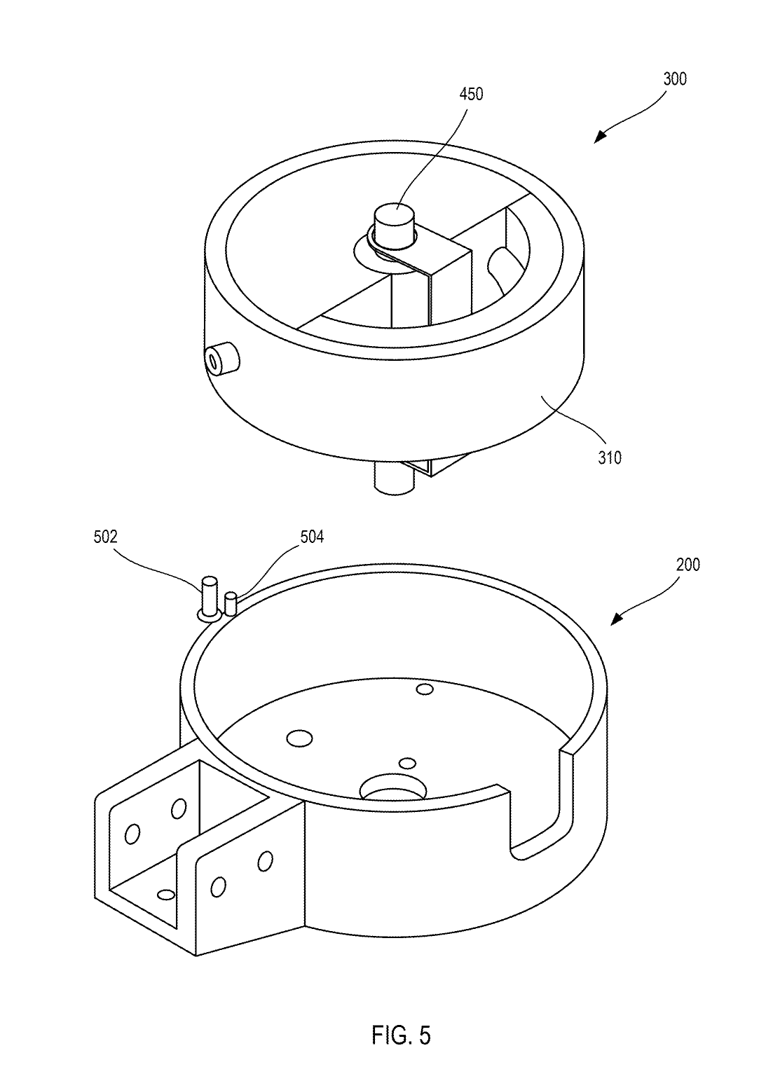

FIG. 5 illustrates an exploded view of the rotating actuator 300 of FIGS. 3 and 4 bolted to a half joint housing 200. As shown, the rotating actuator 300 may be coupled to a half joint housing 200 with an alignment post 504 and a bolt 502. Other embodiments may couple the rotating actuator 300 to the half joint housing 200 by a series of pins, screws, clamps, or other suitable fasteners.

As described with reference to FIG. 3, the actuator cylinder is affixed to the actuator assembly housing 310. The actuator assembly housing 310 is free to rotate on the axle 450 as the piston moves via bearings mounted between the actuator assembly housing 310 and the axle 450. The pistons affixed to the axle 450 cause the actuator assembly housing 310 to rotate. Because the actuator assembly housing 310 is attached to the half joint housing 200, the half joint housing 200 rotates. In other words, in relation to the pistons, the cylinders, the actuator assembly housing 310, and the half joint housing 200 rotate as fluid is moved in and out of the cylinders. A half joint housing is attached to each actuator assembly housing facilitating separate rotation of each joint half.

In some embodiments, multiple stacks of actuators may be used. While FIG. 1 illustrates a pair of actuators in parallel, the actuators can be stacked in a series. Further, the actuators may rotate in phase or out of phase with one another, while still causing a joint to rotate in substantially the same direction. The torque can be double a single actuator or the degrees of rotation can be doubled by simply changing the fluid porting. By way of non-limiting example, the actuators may rotate in an opposite direction for a series port connection (e.g., increasing degrees of rotation), or in a same direction for a parallel port connection (e.g., increasing torque).

Should more than double the degrees of rotation be desired, a first actuator assembly housing, of a first piston linkage assembly, can be connected to a second actuator assembly housing of a second piston linkage assembly. In this way a first actuator housing of a first piston linkage assembly rotates a second actuator housing of a second piston linkage assembly and axle to increase the degrees of rotation, and the first piston linkage assembly operates independently of a second piston linkage assembly (not shown). Should an odd number of actuators be desired, the axle may be attached to a single actuator housing on one end and another end of the axle may be connected directly to the joint housing.

For example, a single actuator (e.g., the actuator of FIG. 1) may rotate approximately 90 degrees. However, a plurality of actuators hydraulically and mechanically connected to rotate in series may be coupled together to enable a rotational range greater than 90 degrees. A tee may connect the ports of additional actuators such that the port alignment of a second actuator is a mirror image of a first actuator. For example, two actuators may be coupled to one another and may enable a rotational range of 180 degrees. Similarly, three actuators may be coupled to one another and may allow a rotational range of 270 degrees, and so on in greater multiples of approximately 90 degrees or in multiples of 160 degrees depending on the actuator design.

Additionally, coupling a plurality of actuators together may allow movement in complimentary or opposite directions (e.g., clockwise and counterclockwise rotation). The rotation of each actuator may be controlled by a single directional valve or valve assembly. The valve assembly may be coupled to a plurality of ports of the actuators. Further, the valve assembly may couple (e.g., fluidly couple or enable fluid communication between) similar ports (e.g., input port) in a common or parallel configuration (e.g., via a T-connector).

As described, the axle coupled to the linkage mechanisms may couple the actuators together. The axle may extend to couple a greater number of actuators (e.g., three actuators, four actuators, etc.). One actuator may form a first half of the joint assembly, and another actuator may form a second half of the joint assembly.

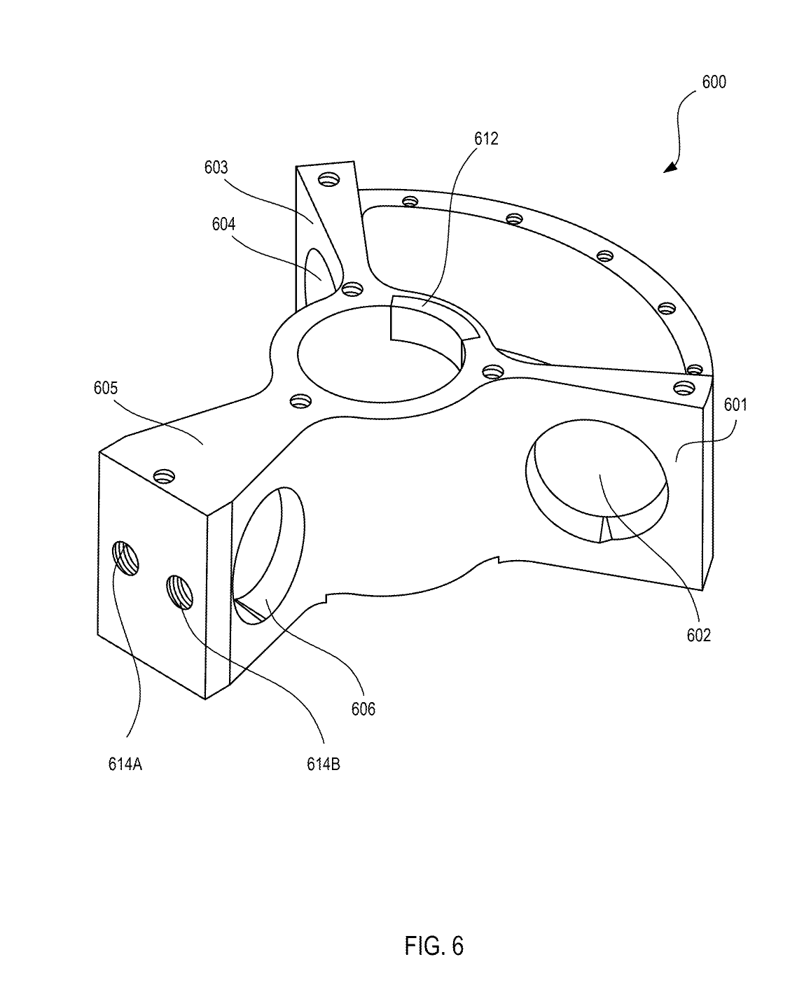

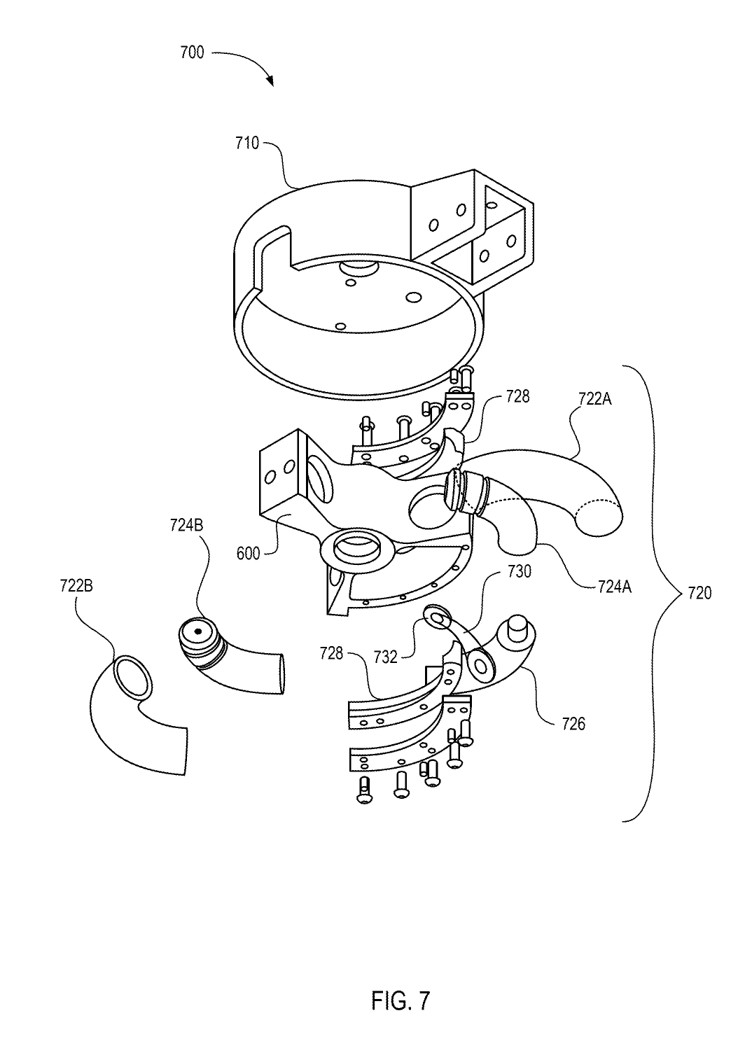

FIG. 6 illustrates a perspective view of a weld base 600 to which actuator cylinders may be brazed. In some embodiments this weld base may be attached to a robotic joint housing as an alternate to the housing 310 of FIG. 5. While actuator 310 may produce 160 degrees rotation, the actuator of FIG. 6 may produce 90 degrees rotation. However, the actuator of FIG. 6 and FIG. 7 produces more torque since the surface area of the piston producing torque (Force equals pressure times area) is greater than piston area of FIG. 3, due to the reduction of piston surface by the piston rod. The weld base 600 may comprise one or more arms 601, 603, 605 coupled to a core 610.

As shown, some of the arms 603, 605 feature apertures 602, 604 and one arm 605 features a cylinder mount 606. The apertures 602, 604 may allow an actuator cylinder to be placed through the arms 603, 605. The cylinder mount 606 may couple to an actuator cylinder and provide support. In some embodiments, the fluid ports 614 of an actuator cylinder may be integrated into the cylinder mount 606.

The core 610 of the weld base 600 may comprise a set of notches or slots 612 for the piston linkage mechanism to attach to the axle. For example, the weld base 600 can have a notch on both sides of the core 610 for the piston linkage mechanism to attach to the axle in two positions.

In some embodiments, the actuators described with reference to FIGS. 1-6 may be used to form a ball joint. For example, the linkage mechanism works well with the ball joint of U.S. Pat. No. 9,375,852, FIG. 38. In the ball joint design, a single actuator as described above has an axle connected to another actuator of the ball joint. For instance, the axle of the single actuator couples to an orthogonal actuator so that rotation of the axle rotates the orthogonal actuator. The orthogonal actuator may be permanently affixed to the axle with bearings to prevent side loading of the second actuator on the first actuator.

FIG. 7 is a simplified exploded view of a portion 700 of a hydraulic joint (e.g., a robotic hydraulic joint) using the weld base 600 of FIG. 6, according to one embodiment. In some embodiments, a complete robotic joint will have another matching portion like the portion 700 illustrated in FIG. 7. The portion 700 includes a housing 710 and an inner actuator 720. The inner actuator 720 includes actuation cylinders 722A, 722B, pistons 724A, 724B, a piston linkage mechanism 726, and a guide mechanism 728, similar to the actuation cylinders 102, the pistons, and the piston linkage mechanism 110, respectively, of FIG. 1.

A piston assembly may include two pistons 724A, 724B. Each piston 724A, 724B may be disposed within an interior of the toroidal actuation cylinders 722A, 722B (e.g., within a single cylinder or portions of both cylinders). The piston assembly may further include a linkage mechanism or more specifically a piston linkage mechanism 726. The linkage mechanism 726 may couple the pistons 724A, 724B together. More specifically, the linkage mechanism 726 may connect, support, and guide rotation of the two pistons 724A, 724B during operation of the dual directional actuator.

In certain embodiments, the pistons 724A, 724B may form a single piston with two piston heads. The single piston may travel between the two actuation cylinders 722A, 722B as part of a dual actuation bi-directional actuator. In some embodiments, the linkage mechanism 726 may rotate in-line with the pistons 724A, 724B, with the pistons 724A, 724B and the linkage mechanism 726 rotating about a common radius of rotation (e.g., the center of the weld base 600).

In addition to coupling the pistons 724A, 724B, the piston linkage mechanism 726 may translate the rotational movement to an axle (not shown). To translate the rotational movement, the piston assembly may comprise a piston-axle bridge 730 and a piston-axle linkage 732. The piston-axle bridge 730 may connect the linkage mechanism 726 to the piston-axle linkage 732. The piston-axle linkage 732 may couple to an axle. As shown, the piston-axle linkage 732 may be a ring. In other embodiments, the piston-axle linkage 732 may comprise any device that can affix to an axle such as a clamp, pin, or screw. In some embodiments, the piston-axle bridge 730, the linkage mechanism 726, and/or the piston-axle linkage 732 may be a continuous single member. In some embodiments, the piston-axle bridge 730, the linkage mechanism 726, and/or the piston-axle linkage 732 may be coupled via fasteners.

The guide or support mechanism 728 may act as a bearing or sidewall of the actuator 100. Further, the guide mechanism 728 may support or guide the coupled pistons 724A, 724B as they travel within the actuation cylinders 722A, 722B (e.g., during operation of the dual directional actuator 100). The guide mechanism 728 may be coupled to the actuator housing 710 by a series of pins, screws, clamps, or other suitable fasteners.

A second mirror-image inner actuator (not shown) and housing (not shown) would connect to the inner actuator 720 and housing 710 by an axle (not shown). The axle would be affixed to one side of the housing 710. The second mirror image housing is free to rotate around the axle in relation to the housing 710 with the assistance of ball bearings (not shown) as one embodiment. Thrust bearings (not shown) are affixed between the inner actuator 720 and the second inner actuator in order to allow reduced friction during rotation. An inside of the actuation cylinders 722A, 722B may be electro-polished to create a good surface finish. To decrease the friction between the actuation cylinders 722A, 722B and seals of the pistons 724A, 724B, a Teflon coating may be added to the inside of the actuation cylinders 722A, 722B.

To reduce the cost of a robotic joint and increase the degrees of rotation, a rotating joint actuated by fluid may be made from plastic. The plastic joint may be molded from a high-strength plastic such as polyether ether ketone (PEEK), and the PEEK material may be compounded with Teflon to reduce friction. PEEK is an example of a material that is able to withstand high pressures that may be encountered while operating the portion 700 of the hydraulic joint of FIG. 7.

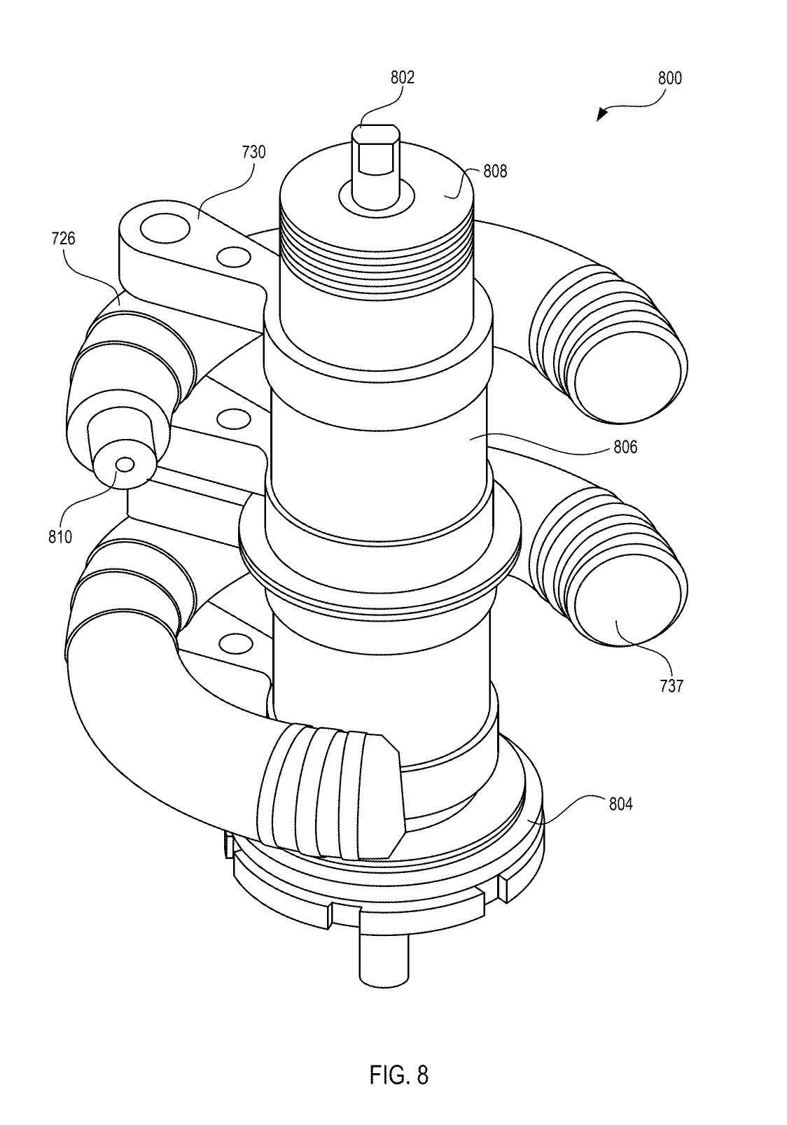

FIG. 8 illustrates an axle assembly 800 with an encoder shaft 802, bearings, and a piston-axle linkage mechanism 726. The axle assembly 800 of FIG. 8 may be used in a hydraulic joint such as the one shown in FIG. 7. For simplicity, support structures such as a weld base and joint housing are not shown.

As shown, the piston linkage mechanism 726 may comprise features to couple to pistons and the piston-axle bridge 730. For example, an end 810 of the piston linkage mechanism 726 may have a reduced diameter to form a post that fits securely into a mating opening in a piston rod. In some embodiments, this post is threaded. In some embodiments, the post and mating opening are affixed with a friction fit.

To couple the piston linkage mechanism 726 to the piston-axle bridge 730, an aperture may be placed through the linkage mechanism 726. A coupling pin may be inserted into the aperture to couple the piston linkage mechanism 726 to the piston-axle bridge 730. In some embodiments, the piston linkage mechanism 726 and the piston-axle bridge 730 are welded together. In some embodiments, the piston linkage mechanism 726 and the piston-axle bridge 730 are a single member. For example, the piston linkage mechanism 726 and the piston-axle bridge 730 may be formed or etched from a single block of material.

The piston-axle bridge 730 couples the piston linkage mechanism 726 to the piston-axle linkage 732. The piston axle linkage 732 is a fitting to facilitate fixing the piston-axle bridge 730 to the axle 808. In some embodiments, piston axle linkage 732 is a part of the piston-axle bridge 730 that permanently affixes the pistons to the axle 808 so that the axle 808 and the piston rotate dependently.

Rather than using a coupling pin at the piston to transfer rotational motion from the actuator to another object, the axle 808 facilitates the transfer of rotation. The axle 808 also facilitates high load capacity. Therefore, it is less susceptible to breaking under load. The encoder shaft 802 measures the rotation of a joint. As shown, the encoder shaft may be positioned through the center of the axle. Additionally, when two pistons are attached separately to an axle by unique piston-axle bridges, the axle may couple the pistons together to form a dual actuator.

Additionally, as shown, a set of bearings may allow components to rotate independent of the axle 808 and piston. For example, an actuator bearing 806 allows an actuator housing to rotate independent of the axle and piston. Similarly, a flange bearing 804 may allow the axle to rotate independent of a joint housing. Thus rotation of the axle 808 may be accomplished independent of an enclosure.

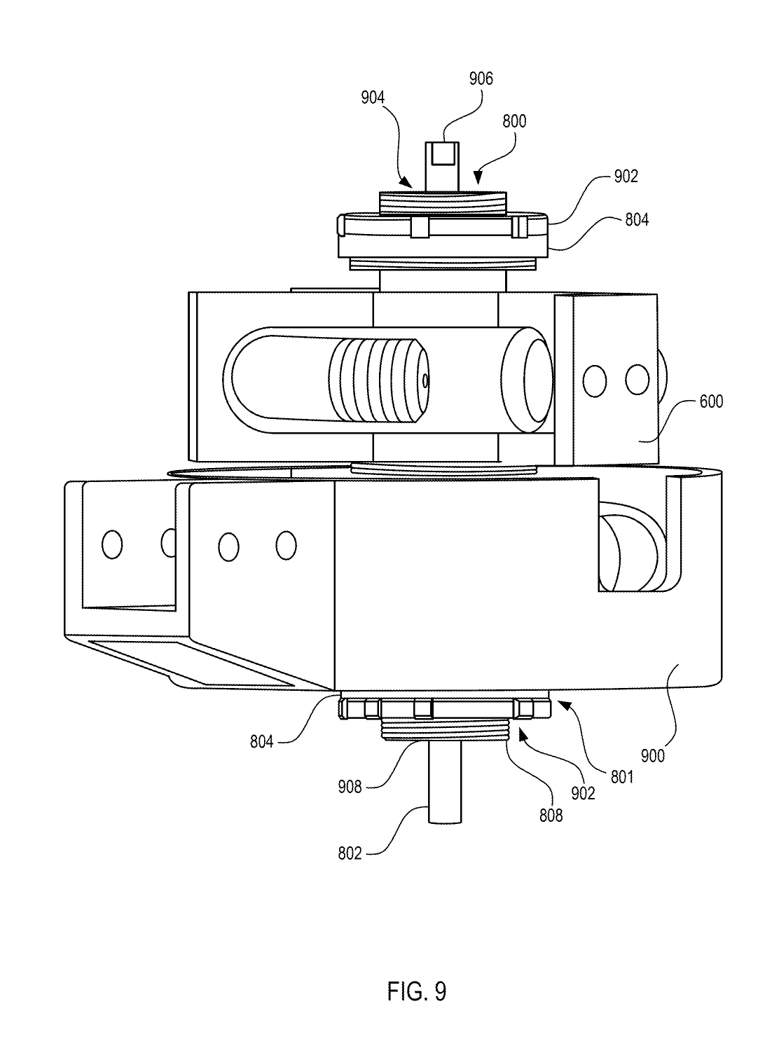

FIG. 9 illustrates a perspective view of a joint housing 900 encompassing the axle assembly 800 of FIG. 8 and an actuator housing (e.g., weld base 600), according to one embodiment. For simplicity, a half of the joint housing 900 is not shown to provide a view of the actuator housing.

A lock nut 902 may secure the axle 808 to the housing. To facilitate independent rotation of the axle 808 and the joint housing 900, a flange bearing 804 may be placed between the lock nut 902 and the joint housing 900. The actuator housing 600 is fixed to the joint housing 900 to facilitate dependent rotation of the actuator housing and the joint housing 900. Thus, the axle 808 may rotate independent of the actuator housing 600 and the joint housing 900 by way of roller bearings between actuator housing 600 and axle 808.

To measure the rotation, the encoder shaft 802 may be fixed to one joint housing and rotate independent of a second joint housing. For example, an encoder shaft bearing 904 may allow the encoder shaft 802 to rotate at a first end 906 relative to half a joint housing, and a second end 908 of the encoder shaft 802 may be fixed to the other half of the joint housing 900.

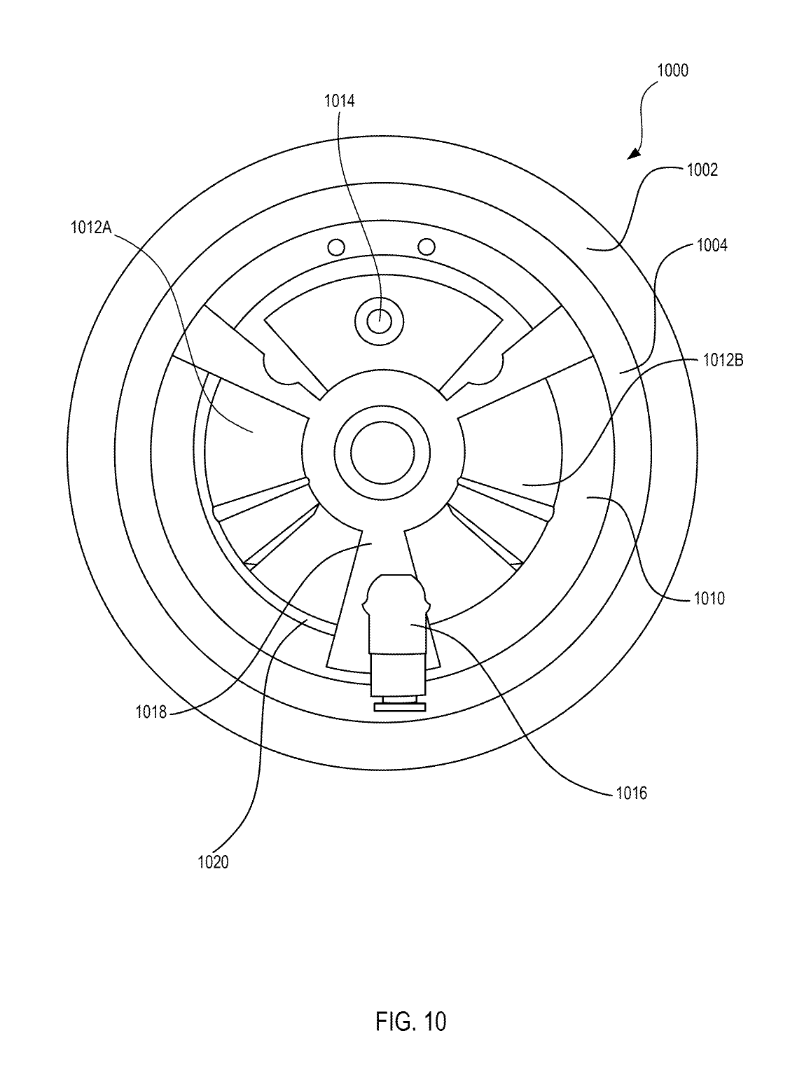

FIG. 10 illustrates a planar view of the front side of a hydraulic rotary joint 1000 comprising an external axle 1002. Normally an axle is in the center of the hydraulic actuator, but in this embodiment, the external axle 1002 is on the outside of the internal actuator 1010 and the actuator is inside the external axle 1002. The external axle 1002 allows for the creation of very stable small hydraulic rotary actuators.

The internal workings of the hydraulic rotary joint 1000 are illustrated in the planar front view of FIG. 10. The hydraulic rotary joint 1000 may comprise one or more internal actuators surrounded by an axle 1002. A bearing 1004 may allow the axle 1002 to rotate independent of the internal actuator 1010. The bearing may be a constructed from solid bronze oil impregnated material, roller bearings, Teflon-polymer composites, or other commonly known bearing systems.

As shown, the internal actuator 1010 may comprise a piston 1012, a fluid port 1016 and an actuator housing 1018. The internal actuator 1010 may actuate based on fluid pressure. For instance, a fluid medium may flow into the fluid port and through the actuation cylinder 1020. The pressure caused by the fluid entry may move the piston 1012A, 1012B. The drive pin 1014 may couple to the piston 1012 and enable a transfer of rotational power from an actuator to another actuator, device, object, or joint. However, in some embodiments, rather than a drive pin, a piston linkage assembly may be used as discussed with reference to FIGS. 1-9.

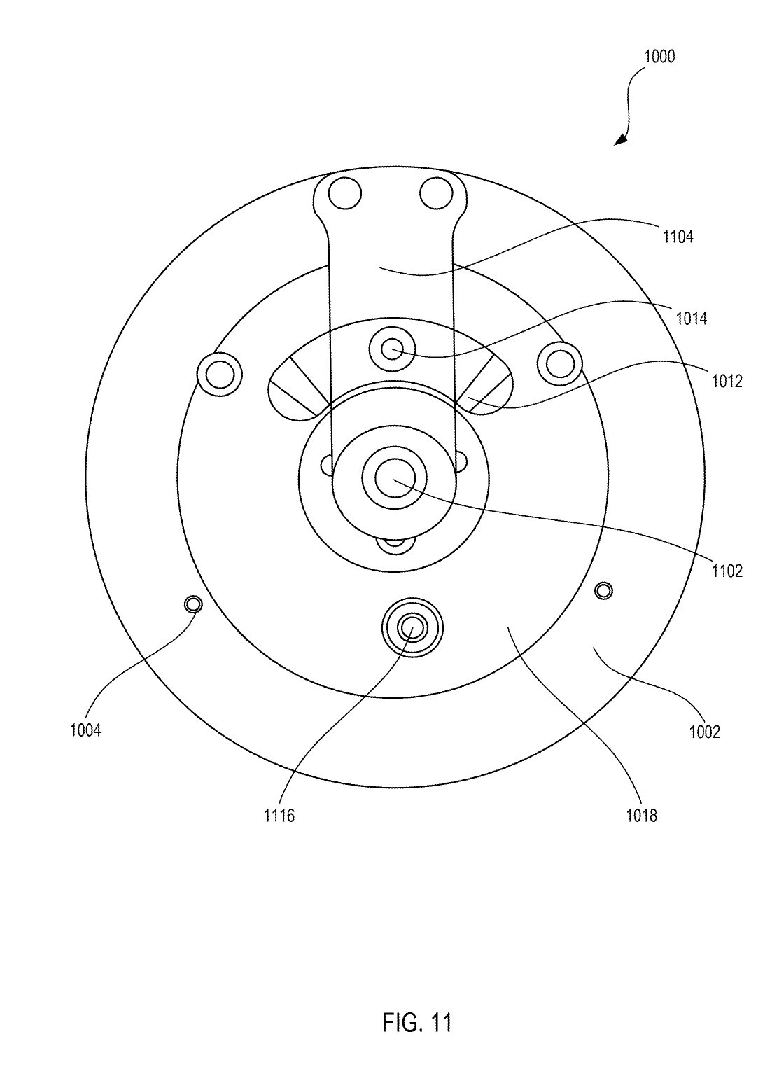

FIG. 11 illustrates a planar view of the front side of the hydraulic rotary joint 1000 of FIG. 10 comprising an external axle 1002. A second fluid port 1116 may be located on the back of the hydraulic rotary joint 1000 to control movement of the piston 1012. In other embodiments, the fluid ports may be on the same side of the hydraulic rotary joint 1000.

As shown, the drive pin 1014 is connected to the axle linkage 1104. The axle linkage 1104 is also connected to the external axle 1002. Therefore, the axle linkage 1104 couples the piston 1012 to the external axle 1002. Thus, movement of the piston 1012 may be transferred to movement of the external axle 1002 through the axle linkage 1104. For example, if the piston 1012 rotates a first direction, the axle linkage 1104 swings, moving the axle 1002 with it. The bearings 1004 facilitate rotation of the external axle 1002 dependent of the actuator housing 1018.

The axle linkage 1104 may also couple an encoder shaft 1102 at the axis of rotation. The encoder shaft 1102 may measure the degrees rotated by the external axle 1002. In some embodiment the encoder shaft 1102 or central shaft may provide additional stability for the axle linkage 1002.

While the hydraulic rotary joint 1000 shown in FIGS. 10-11 illustrates a single axle linkage 1104, in some embodiments, multiple axle linkages may couple the drive pin 1014 to the external axle 1002. For example, one axle linkage may be coupled to each side of the piston 1012. In some embodiments, the two axle linkages may be connected together by a common drive pin.

While the illustrated embodiment demonstrates an axle linkage 1104 coupled to the edge of the axle 1002, the axle linkage may be contained inside the axle and attached with screws normal to the surface of the axle. In some embodiments where multiple axle linkages are used, a first axle linkage may be placed on the exterior edge of the axle as shown, and a second axle linkage may be contained within the axle and attached to the interior surface of the axle.

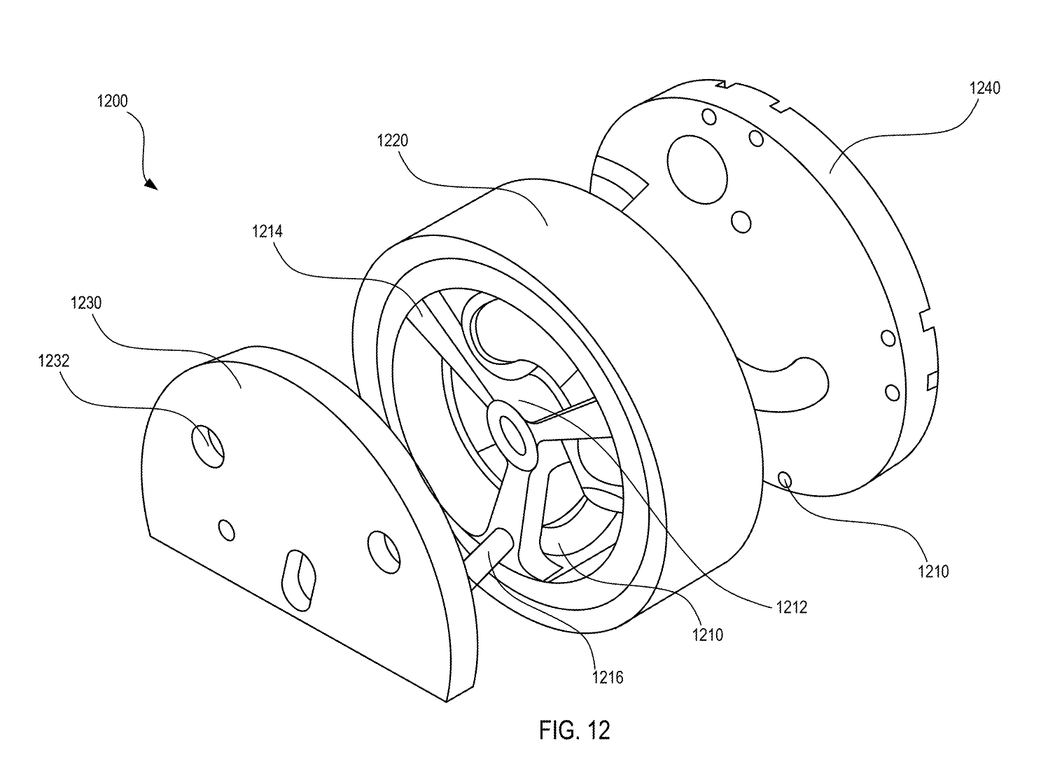

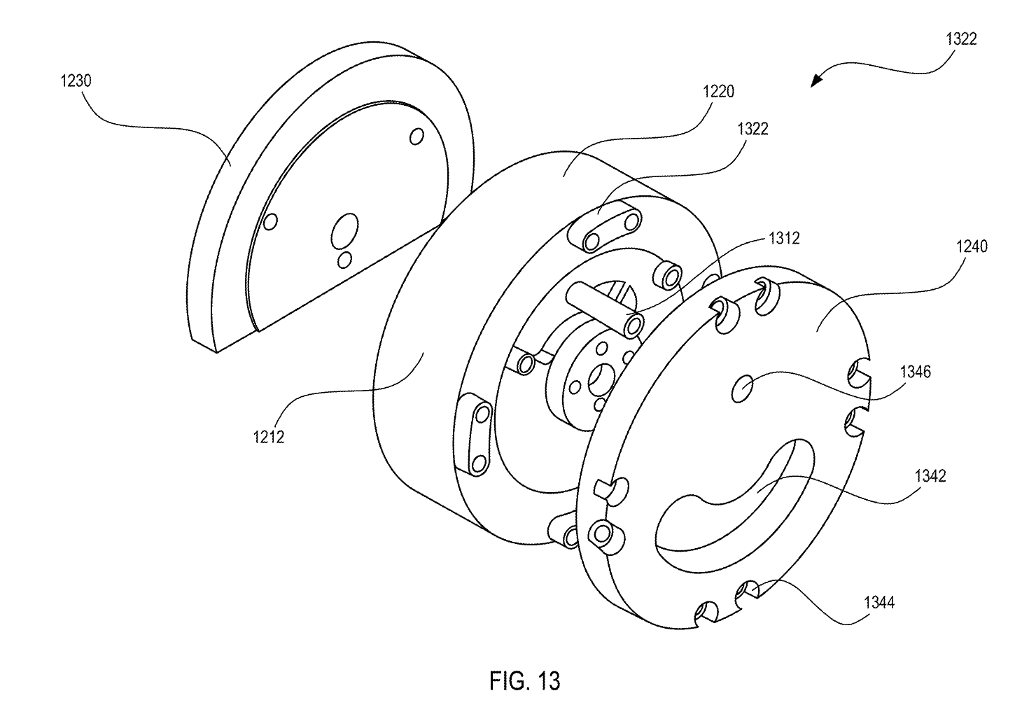

FIG. 12 illustrates a front exploded view of a hydraulic rotary joint 1200 with link plates. As shown, the dual directional actuator 1210 may include a dual directional actuator 1210 and an external axle 1220. The actuator housing 1212 may be connected to a first joint link plate 1230 as illustrated in FIG. 12, and the axle 1220 may be connected to a second joint link plate 1240 (discussed in more detail with reference to FIG. 13) to cause rotation of the hydraulic rotary joint 1200 and to perform work.

The joint link plates may include a set of apertures 1232 to attach to the actuator housing 1212 or the axle 1220. The apertures 1232 are to facilitate entry of fasteners. For example, as shown, in some embodiments, the actuator housing 1212 may feature threaded bolt receiving holes 1214. A manufacturer may align the apertures 1232 with the threaded bolt receiving holes 1214 and introduce a bolt to couple the first joint link plate 1230 and the actuator housing 1212. Other fastening methods may include metallic and sonic welding.

The joint link plates may be configured to provide access to fluid ports of the dual directional actuator 1210. For example, as shown, the first joint link plate 1230 is a semi-circle. This shape allows external hoses to couple to a first fluid port 1216. Additionally, the external hoses and first fluid port 1216 may rotate or move with little to no interference from the first joint link plate 1230.

The axle 1220 may rotate independent of the first joint link plate 1230. In some embodiments, the first joint link plate 1230 is configured to not contact the axle 1220. For example, the diameter of the first joint link plate 1230 may have a smaller diameter than the interior of the axle 1220. In some embodiments, the first joint link plate 1230 may be a similar diameter to the axle 1220, and include a bearing to interface between the axle 1220 and the first joint link plate 1230. In some embodiments, the first joint link plate 1230 may include a perimeter with a smaller width than the center of the first joint link plate 1230, and the smaller width of the perimeter may offset the first joint link plate 1230 from the axle 1220 to prevent interference.

Each joint link plate may be attached to a link to cause rotation of a connection between one or more joints. For example, the first joint link plate 1230 may be coupled to a first link, and the second joint link plate 1240 may be coupled to a second link. As the dual directional actuator 1210 operates, the first and second link rotate relative to one another. In some embodiments, the first and second links may couple between hydraulic rotary joints for a complex joint with greater degrees of movement.

Links may be coupled to the joint link plates via the apertures 1232. For example, a bolt may extend through the link and the aperture of the first joint link plate 1230 and be fastened to the threaded bolt receiving holes 1214. In some embodiments, the first link plate may include additional mating elements to couple to the links. In some embodiments, the links may be welded or fixed directly to the joint link plates. In some embodiments, joint link plates may include an integrated link. For instance, the joint link plate and the link may be integrated into a single piece.

FIG. 13 illustrates a back exploded view of the hydraulic rotary joint 1200 of FIG. 12 with link plates. The second joint link plate 1240 may couple to the axle 1220 and a drive pin 1312.

As shown, the second joint link plate 1240 comprises apertures 1344 that align with threaded bolt receiving holes 1322 on the axle 1220. A manufacturer may align the apertures 1344 with the threaded bolt receiving holes 1322 and introduce a bolt to couple the second joint link plate 1240 and axle 1220. As shown, the threaded bolt receiving holes 1322 may be raised to separate the second joint link plate 1240 from the actuator housing 1212. Alternatively or in addition, a similar raised feature may be incorporated in the second joint link plate. By separating the second joint link plate 1240 from the actuator housing 1212, the second joint link plate 1240 can rotate relative to the actuator housing 1212 without interference.

The drive pin 1312 may extend into or through a pin aperture 1346 of the second joint link plate 1240. A bolt or other fastener may secure the drive pin 1312 in the pin aperture 1346. In some embodiments, the drive pin may be the piston linkage assembly 110 of FIG. 1.

The second joint link plate 1240 may be configured to provide access to a second fluid port. For example, as shown, the second joint link plate 1240 comprises an arched slot 1342. The arched slot provides an opening to allow external hoses to couple to a second fluid port. Additionally, the second joint link plate 1240 may rotate without interfering with access to the second fluid port.

If more than one actuator is used (not shown), the additional actuator housing may be connected to the first joint link plate 1230, to the second joint link plate 1240, directly to the actuator housing 1212, or to the axle 1220. Additional actuators may be fluidly connected in series or parallel to increase the degrees of rotation or the torque of the hydraulic rotary joint 1200 as necessary. In parallel-fluidly connected actuators, the actuator housing of each actuator may be connected together, with the actuator housings connected to a common first joint link plate, the pistons connected to the axle, and the axle connected to a second link plate. This produces a 2 times the torque of a single actuator when only 2 actuators are fluidly connected in parallel.

The additional actuators (not shown) may be attached to the first or second joint 1230, 1240 link plate and to an additional third or fourth joint link plate (not shown) to increase the degrees of rotation when fluidly connected in series. The joint link plates may be used in various combinations connected to either the axle, link, or actuator housing depending on the torque and degrees of rotation desired.

The link pates shown in FIGS. 12-13 may be used in combination with the axle linkage shown in FIG. 11. For example, link plates may be coupled to the ends of an external axle and one or more axle linkages may be coupled to the interior surface of the axle. In some embodiments, each actuator housing may be connected to a joint link plate, and the piston of each actuator is connected to the axle by an axle linkage or joint link plate. In some embodiments, the joint link plate and the axle linkage may be integrated into a single piece. The additional actuators may be connected to the axle internally by screws through the axle into an axle linkage.

The joint link plates may allow the hydraulic rotary joint 1200 to be sealed to an external environment while allowing hoses to connect to the fluid ports of the joint. For example, the actuator housing 1212 may seal piston ends of an actuator while exposing a piston coupler and drive pin. The joint link plates may cover the exposed portion and still allow rotational movement to be transferred.

In some embodiments, the area inside the actuator housing may be substantial in large actuators of this design. For example, a tank turret may be implemented using this design. The area inside the actuator housing can be used for placement of items such as hoses, fittings, and people.

FIG. 14 illustrates a perspective view of a ball joint actuator 1400 comprising three hydraulic rotary joints with external axles and link plates 1402, 1404, 1406. As shown, the joint link plates, actuator housing, or the axle of each hydraulic rotary joint may be connected to orthogonal hydraulic rotary joints. The link plates comprise mating features to facilitate the attachment of the orthogonal hydraulic rotary joints. This allows the ball joint actuator 1400 to move a connect link in any direction of a Cartesian coordinate system. Additional hydraulic rotary joints may be used to increase the torque of rotational actuation of the ball joint actuator 1400.

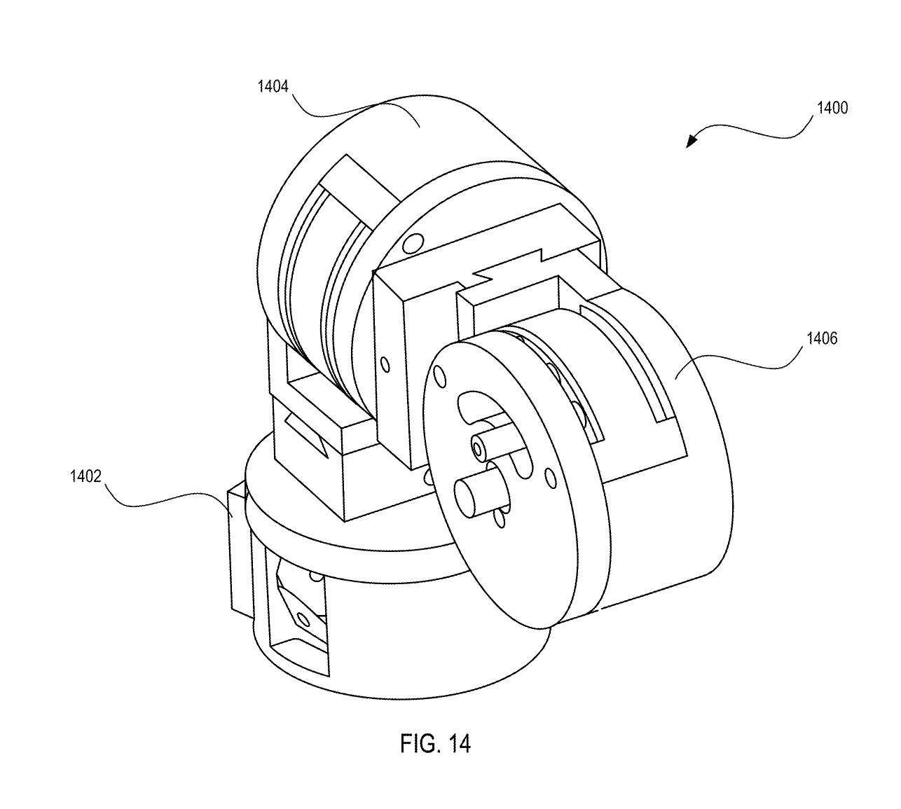

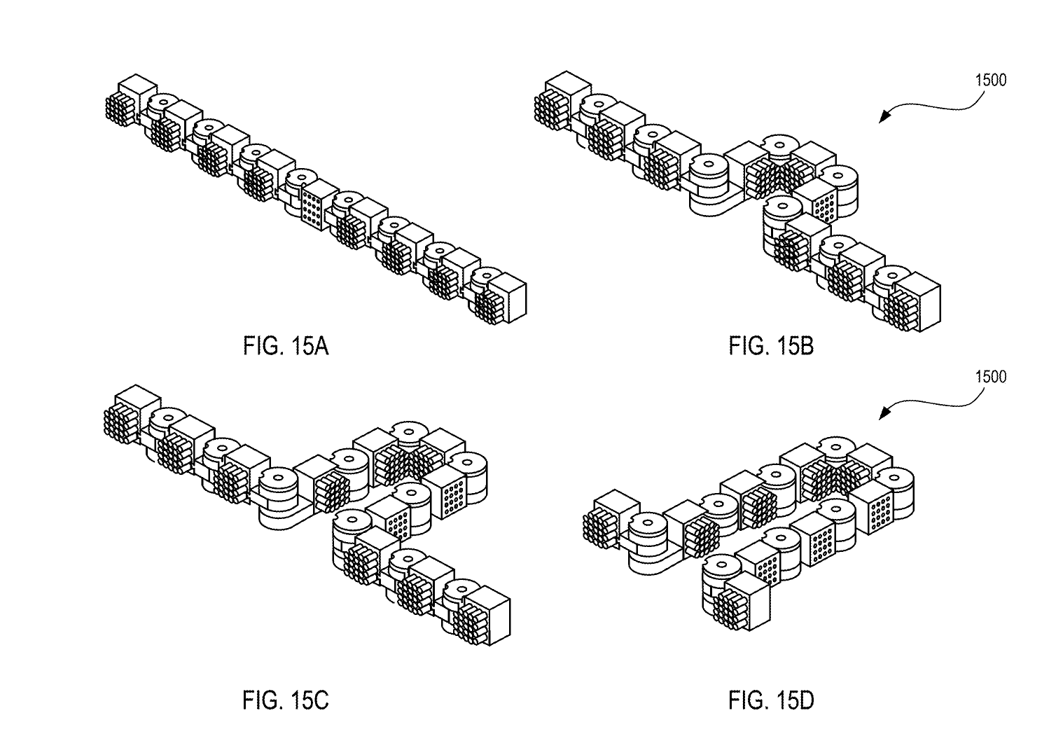

FIGS. 15A-D illustrate perspective views of a robotic hand in various pre-grasping postures utilizing hydraulic rotary joints with internal or external axles. These postures allow conformal grasping of different size objects. For example, FIG. 15A illustrates a posture for grasping with a 28 inch span, FIG. 15B illustrates a posture for grasping with a 21 inch span, FIG. 15C illustrates a posture for grasping with a 14 inch span, and FIG. 15D illustrates a posture for grasping with a 7 inch span. The selection of the pre-grasp postures is dependent on the volume of the object to be grasped by the conformal gripper, which may be determined by a vision system.

When two actuators are in parallel the actuator housings are connected together and the torque is double a single actuator, and when actuators are in series each actuator housing is connected to a joint link and the rotation of the joint is double the rotation of each single actuator. In some embodiments, the actuators may switch between fluidly parallel and series using a switching system. For example, a damper may direct flow of fluid into an actuator to change the behavior of the actuators, and a set of controllable pins may couple or uncouple the actuator housings.

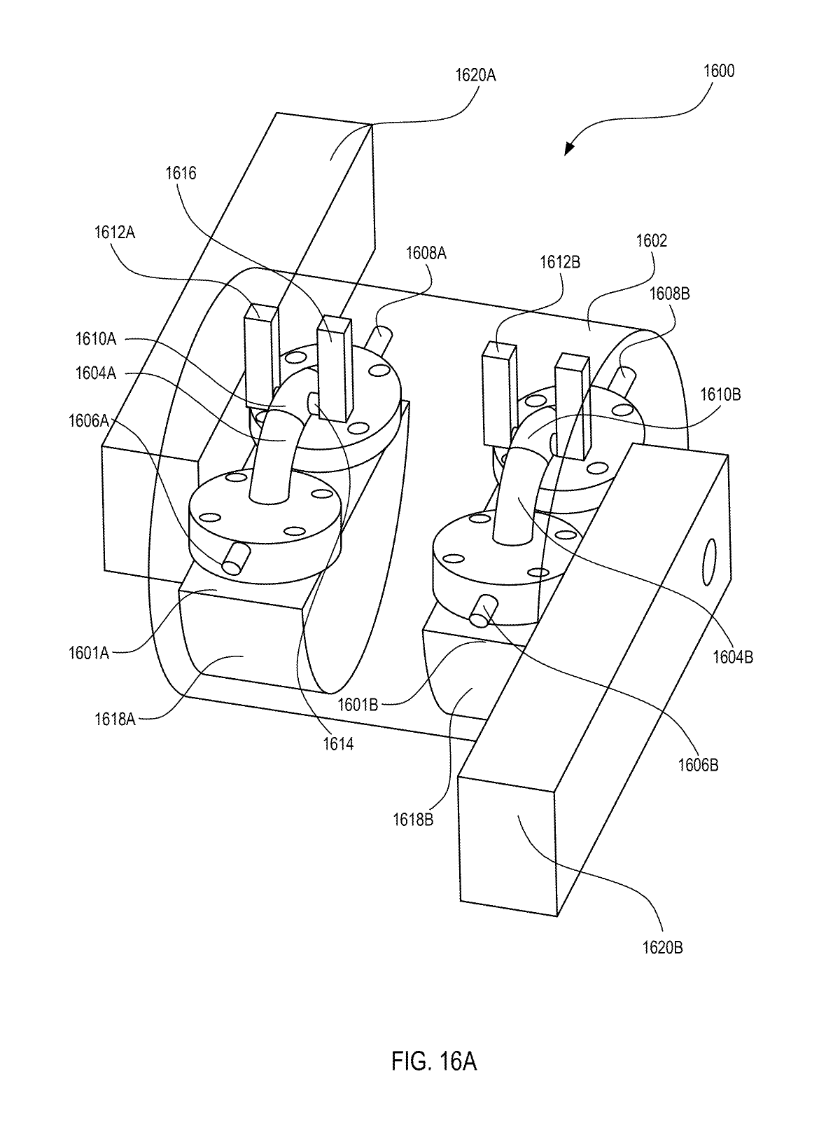

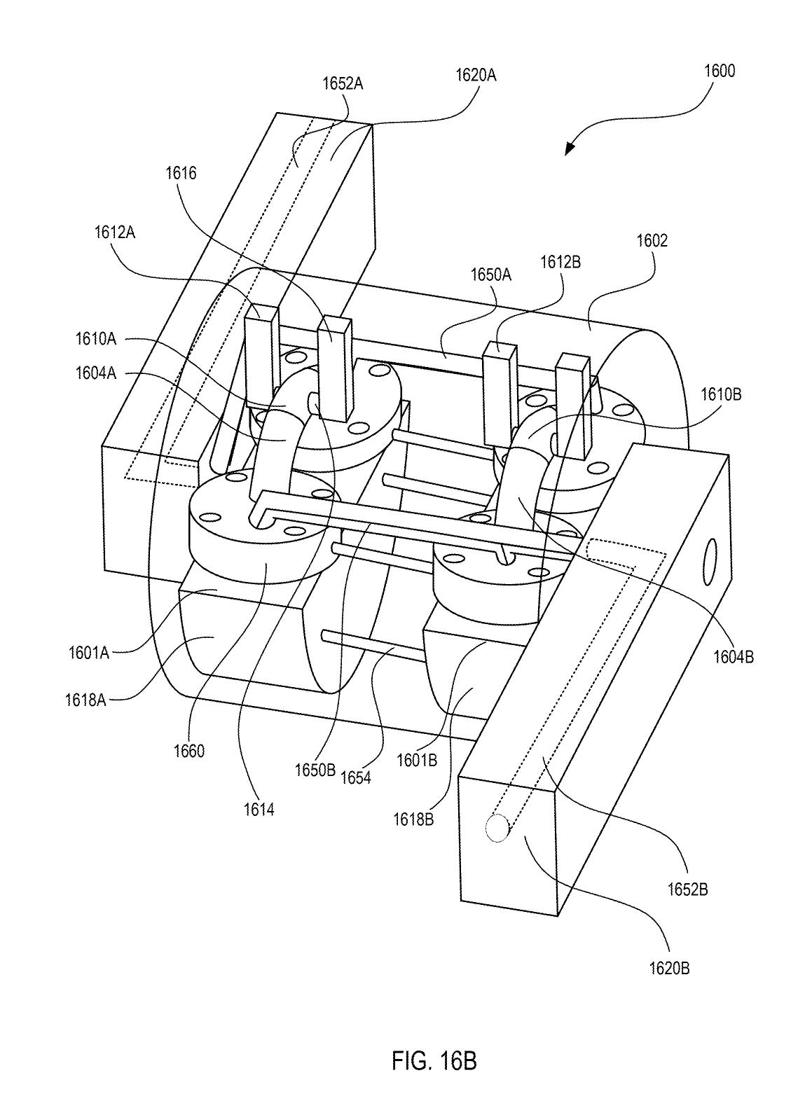

FIGS. 16-19 illustrate embodiments of a hydraulic rotary actuator with an external axle. Many items such as both internal and external fittings, connecting components between the actuators, and link details are not shown in order to simplify the explanation. Other aspects disclosed in reference to the other figures herein could be integrated into this design such as a manifold for internalizing hoses and an internal axle in place of an external axle. The hoses and ports are not illustrated, but the hoses may be run through the links with internal manifolds to eliminate hoses external to the joint.

FIG. 16A illustrates a perspective view of a hydraulic rotary joint 1600 with an external axle 1602 and internal piston axle linkage 1612A, 1612B. The two actuators 1601A, 1601B of the embodied hydraulic rotary joint 1600 produce both torque and rotation. The actuators 1601A, 1601B include cylinders (not shown), pistons 1604A, 1604B, and fluid ports 1606A, 1606B, 1608A, 1608B. A piston linkage assembly 1610A, 1610B couples the pistons 1604A, 1604B to an internal piston axle linkage 1612A, 1612B.

The internal piston axle linkage 1612A, 1612B comprises a drive pin 1614 and a piston-axle bridge 1616. The drive pin 1614 may extend through an aperture in the piston linkage assembly 1610A, 1610B. The piston-axle bridge 1616 may couple the drive pin 1614 to the external axle 1602.

In this embodiment, the pistons 1604A, 1604B drive the axle 1602 surrounding the actuators to cause rotary motion of the axle 1602. A fluid media (e.g., hydraulic fluid or air) may flow into the cylinders via the fluid ports 1606A, 1606B and cause the pistons 1604A, 1604B to change position. The change in piston position results in movement of the internal piston axle linkage 1612A, 1612B. The rotational motion of the axle 1602 may be accomplished by affixing the axle 1602 to the internal piston axle linkage 1612A, 1612B. Because of this coupling, when the internal piston axle linkage 1612A, 1612B moves so does the axle 1602. Thus, introducing fluid media causes a rotational movement output of the actuators 1601A, 1601B. As shown, in some embodiments, the internal piston axle linkage 1612A, 1612B may be on both sides of each actuator for more stability.

In some embodiments, a first actuator housing 1618A is connected to a first link 1620A and a second actuator housing 1618B is connected to a second link 1620B to double the degrees of rotation compared to a single actuator with series port connection or double the torque with parallel port connection. The links may couple to the external axle and couple to other devices to transfer the rotational force of the external axle. The connections of the links and actuator housings are not shown. In some embodiments, the ports of actuator 1 and actuator 2 are connected together by a tee fitting.

The ports of the actuators 1601A, 1601B may be connected opposite by the tee connectors so that the actuators rotate in opposite directions such that port 1606A is connected to port 1608B and port 1608A is connected to port 1606B. The reverse fed ports may produce double the rotation of a single actuator. For example, if a set of actuators produce 150 degrees of rotation each, connected together in this arrangement the hydraulic rotary joint 1600 produces 300 degrees of rotation of link 1620A with respect to link 1620B.

In other embodiments, the actuators 1601A, 1601B may produce double the torque instead of double the rotation of the single actuators. To produce double the torque of each actuator the connections to actuator housing, ports, and links must be changed. For the hydraulic rotary joint 1600 to produce double the torque of a single actuator, the actuator housing 1618A is fixedly connected to link 1620A, the actuator housing 1618B is fixedly connected to actuator housing 1618A, and link 1620B is fixedly connected to the axle 1602. In this embodiment, the ports of actuator 1601A and actuator 1601B may be connected together by a tee fitting to facilitate rotation in the same direction (i.e., the ports are connected like port to like port) such that port 1606A is connected to port 1606B and port 1608A is connected to port 1608B. In this embodiment a bearing (not shown) is located between the first and second actuator housings 1618A, 1618B and the external axle 1602. A bearing such as a roller bearing may be press fitted into the external axle.

The connections of the actuators 1601A, 1601B to the links 1620A, 1620B are not shown, but any method may be used for attaching the axle 1602 to the link 1620A, 1620B. For instance, the axle may be extended sufficiently to fit the links 1620A, 1620B inside. In some embodiments, screws could secure the link 1620A, 1620B to the axle 1602.

Further, the connections of the actuator housing 1618A, 1618B to the links 1620A, 1620B and the connection between the actuator housings 1618A, 1618B are not shown, but various methods could be used. For example, screws may attach the housings together with standoffs between the housings to maintain separation distance.

Additionally, the connections of the external axle 1602 to the internal piston axle linkages 1612A, 1612B are not shown. Various methods may be used, for example, one method is to secure the internal piston axle linkage 1612A, 1612B to the external axle 1602 with a screw through the external axle 1602 into the internal piston axle linkage 1612A, 1612B. In some embodiments, the internal piston axle linkages 1612A, 1612B may be welded to, fused to, or otherwise permanently affixed to the external axle 1602.

FIG. 16B illustrates a perspective view of a hydraulic rotary actuator with an external axle and internal piston axle linkage with manifolds. A fitting 1650A, 1650B may be used to connect the ports of the actuators 1601A, 1601B together. In some embodiments, the actuators 1601A, 1601B can also function as a standoff between the actuator housings 1618A, 1618B and endcaps 1660.

The fittings 1650A, 1650B may be a press in straight tube between actuator ports. In some embodiments, the fittings are secured by screws securing the housing and endcaps together for parallel port configuration. The fittings 1650A, 1650B may have a lip to secure O-rings into a O-ring pocket in the end cap or housing. O-rings may be pressed into port recesses located in the end cap to prevent leakage between the straight tube fitting and endcap. The straight tube fittings 1650A, 1650B apply pressure to the O-rings by means of pressure applied between the endcaps and actuator housings by securing bolts 1654 or the like.

Securing bolts 1654 may go through a link attached to a first actuator housing, and a nut on the outside of a second actuator housing secures the actuators together to cause engaging pressure on the static O-rings between the straight tubes fittings 1650A, 1650B and the endcaps (or housings) port recesses. Pressure applying securing bolts 1654 may run through the links, actuator housings, and endcaps.

Alternatively, the straight tubes may port fluid into the cylinders through the actuator housing, instead of through the endcap. In some embodiments, hoses and manifolds 1652A, 1652B running to additional joints, wires, and encoders can be housed in the links. Hoses may be attached to internal manifolds 1652A, 1652B in the links via fittings or nuts and ferrules.

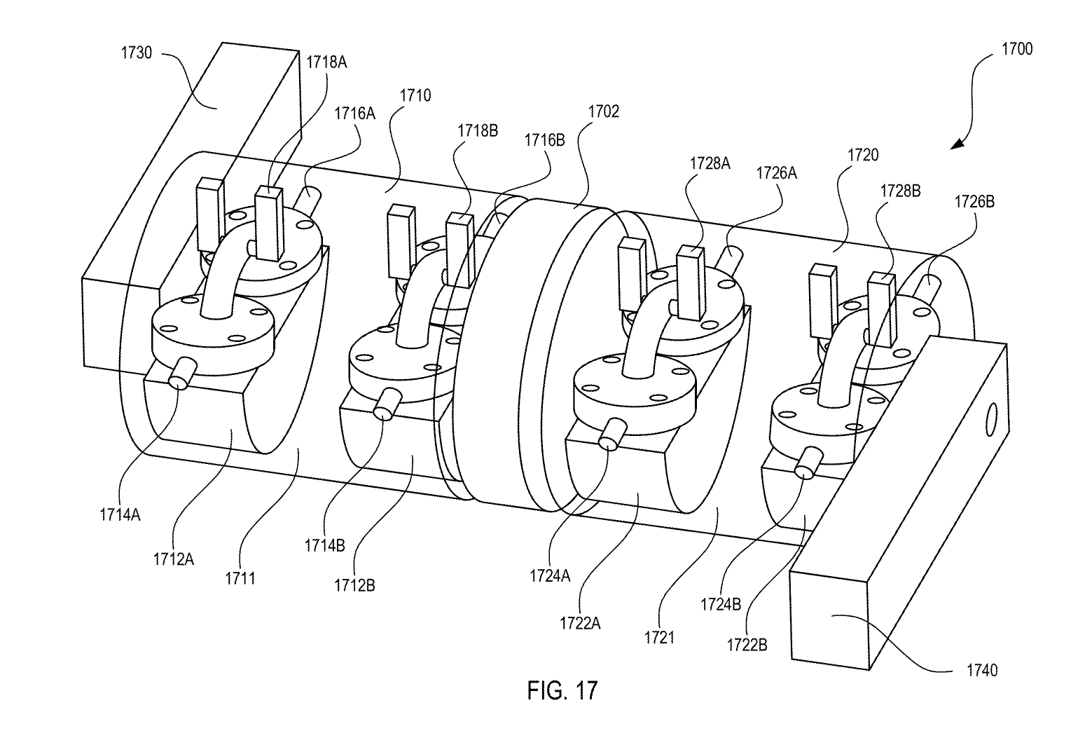

FIG. 17 illustrates an interior perspective view of a stacked hydraulic rotary actuator 1700 with connecting plate 1702 A hydraulic rotary actuator may be extended to generate a range of torque and rotation options as illustrated. Stacking the axles with actuators (axle-actuator assemblies 1710, 1720) together with a connecting plate 1702 allows flexibility in the design of a joint to yield a range of torques and rotations dependent only on the number of axle-actuator assemblies used.

As shown, a stacked hydraulic rotary actuator 1700 may include two axle-actuator assemblies 1710, 1720. These axle-actuator assemblies 1710,1720 can be connected to yield four times the rotation of the individual actuators, four times the torque of the individual actuators, or a combination of torque and rotation between these maximums.

For example, to attain four times the rotation of a single actuator, actuator housing 1712A is fixedly attached to link 1730, actuator housing 1712B is fixedly attached to connecting plate 1702, actuator housing 1722A is fixedly attached to the connecting plate 1702, and actuator housing 1722B is fixedly attached to link 1740. All of the actuators may have common retraction and extension ports connected in common through tee fittings that may be integrated into a manifold to eliminate hoses. Further, to rotate the actuators in the same direction, the embodiment connects together port 1716A, port 1716B, port 1726A, and port 1726B by tee fittings, and port 1714A, port 1714B, port 1724A, and port 1724B are connected together by tee fittings, which causes four times the torque of a single actuator.

Connecting the ports in cross configuration may allow the joint to have four times the degrees of rotation. An example of the cross-port configuration is connecting port 1714A to 1716B and port 1716A to 1714B, and connecting port 1724A to 17266 and 1726A to 17246. Additionally, these ports may be connected together by t connectors to enable a single directional valve to control the joint movement such that ports 1714A, 1716B, 1724A and 1726B are connected together in fluid communication by T connectors, and ports 1716A, 1714B, 1726A, and 1724B are connected in series fluid communication by T connectors which yields four times the rotation of a single actuator.

In all embodiments the pistons are fixedly attached to the axles (1711, 1721) by the piston axle linkages 1718A, 1718B, 1728A, 1728B. These axle-actuator assemblies 1710, 1720 can be stacked together to yield the specified degrees of rotation and torque, which may require an odd number of actuators (not shown). As discussed above, one method of connecting stacked axle-actuator assemblies together yields an embodiment with four times the rotation of a single actuator, but the hydraulic joint will have the torque of a single actuator.

In some embodiments, the stacked hydraulic rotary actuator 1700 may be designed to yield four times the torque of an individual actuator, but the degrees of rotation will be equal to a single actuator in this embodiment. To yield four times the torque of a single actuator, the actuator housing 1712A is fixedly connected to link 1730, actuator housing 1712B is fixedly connected to actuator housing 1712A, axle 1711 is fixedly connected to the connecting plate 1702, axle 1721 is fixedly attached to connecting plate 1702, actuator housing 1722A is fixedly connected to actuator housing 1722B, and actuator housing 1722B is fixedly attached to link 1740. Alternatively, axle 1711 may be fixedly attached to link 1730 and axle 1721 may be fixedly attached to link 1740. The porting to the actuators remains the same in all joints with more than one axle, so that all actuators rotate in the same direction such that port 1716A, port 1716B, port 1726A, and port 1726B are all connected together by tee fittings. And port 1714A, port 1714B, port 1724A, and port 1724B are connected together by tee fittings which yields four times the torque of a single actuator. The actuator and port assembly of FIG. 17 can alternatively be used with an internal axle design.

In some embodiments, the actuators can be connected to yield a combination of increased torque and rotation as compared to a single actuator. For instance, the actuators can be connected to yield two times the torque and two times the rotation of a single actuator. According to one embodiment, to double the torque and double the rotation of a single actuator, the actuator housing 1712A is fixedly attached to link 1730, actuator housing 1712A is fixedly attached to actuator housing 1712B, axle 1711 is fixedly attached to connecting plate 1702, actuator housing 1722A is fixedly attached to connecting plate 1702, actuator housing 1722A is fixedly attached to actuator housing 1722B, and axle 1721 is fixedly attached to link 1740. The ports may be fed and arranged as specified above with the previous two examples.

A combination of these embodiments can be used to yield any practical arrangement of rotation and torque necessary for a specific application. The axle-actuator assemblies 1710, 1720 can be stacked in parallel and the ports of the actuator can be connected in any arrangement to attain the desired rotation or torque.

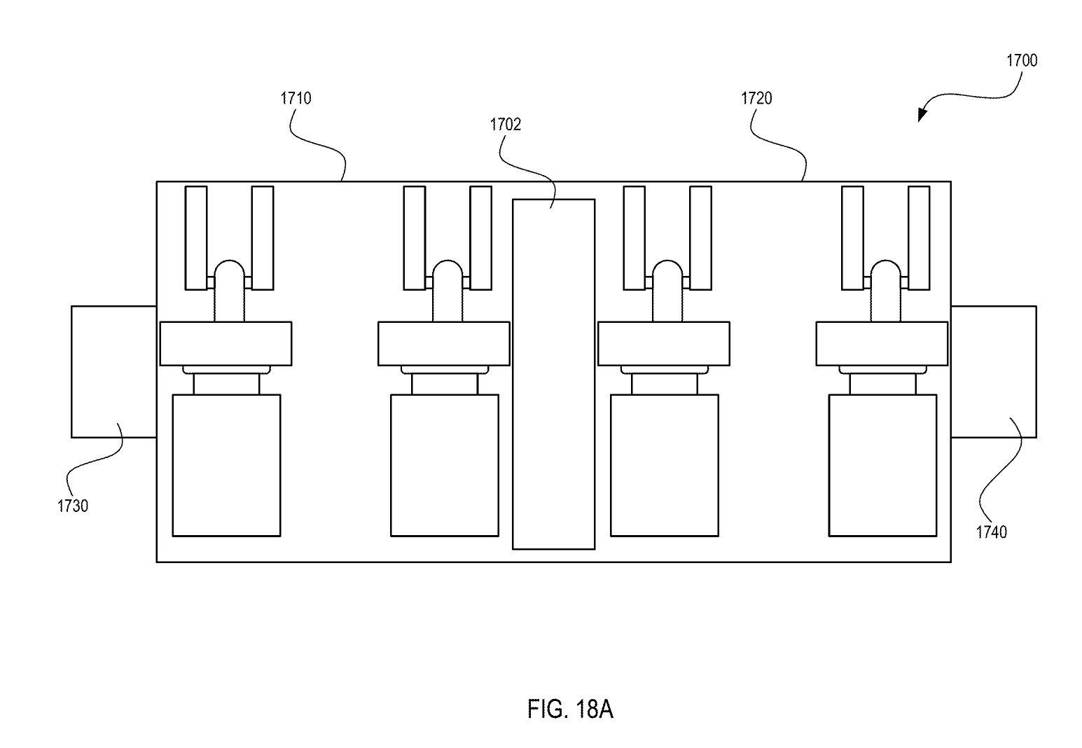

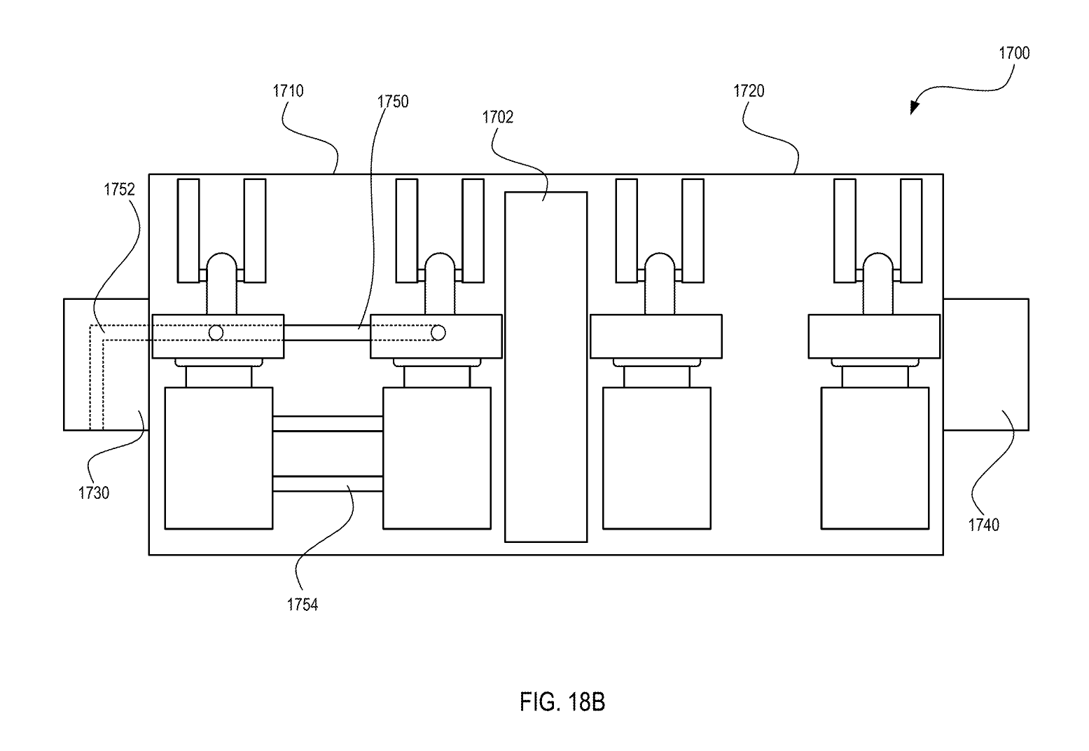

FIG. 18A illustrates a side view of the stacked hydraulic rotary actuator 1700 with connecting plate 1702. While the illustrated stacked hydraulic rotary actuator 1700 has two axle-actuator assemblies 1710, 1720, additional axle-actuator assemblies may be added by replacing one of the links 1730, 1740 with another connecting plate.

FIG. 18B illustrates a side view of the stacked hydraulic rotary actuator with connecting plate 1702 with straight tube fittings 1750 connecting ports together. Straight tube fittings 1750 may be used to connect the ports of the actuators together. In some embodiments, the actuators housings, or straight tube fittings can also function as a standoff between the actuator housings and endcaps 1660.

The straight tube fittings 1750 may be a press in straight tube between actuator ports. The fittings 1750 may connect to internal manifolds in the endcaps, housing and/or links. In some embodiments, the fittings are secured by screws securing the housing and endcaps together for parallel port configuration. The straight tube fittings 1750 may have a lip to secure O-rings into a O-ring pocket in the end cap or housing. O-rings may be pressed into port recesses located in the end cap to prevent leakage between the straight tube fitting and endcap.

The straight tube fittings 1750 may apply pressure to the O-rings by means of pressure applied between the endcaps and actuator housings by securing bolts 1654 or the like. Securing bolts 1754 may go through a link attached to a first actuator housing, and a nut on the outside of a second actuator housing secures the actuators together to cause engaging pressure between the static O-rings between the straight tube fittings 1750 and the endcaps (or housings). Pressure applying securing bolts 1754 may run through the links, actuator housings, and endcaps.

Alternatively, the straight tubes may port fluid into the cylinders through the actuator housing, instead of through the endcap. In some embodiments, hoses running to additional joints, wires, and encoders can be housed in the links. The hoses may be attached to the links via fittings or nuts and ferrules. Manifolds 1752 may connect to hoses (not shown) on single or both ends of a joint link 1730 and the hose connection may be on either end of the link. In embodiments where each robotic joint has a control valve for independent joint rotational control, each joint will require two or more isolated hoses. In robotic joints without independent joint control, a single pair of hoses may supply directional control and pressure to multiple joints 1700 through common hydraulic lines. The joints can connect to a common hydraulic line wherein the internal manifold 1752 has a t-connector internally for connecting joint 1700 to a supply fluid from a preceding source and supply fluid to a subsequent joint. In this way a single pair of hoses from a directional valve can control multiple joints causing opening and closing of a robotic hand, without individual joint control.

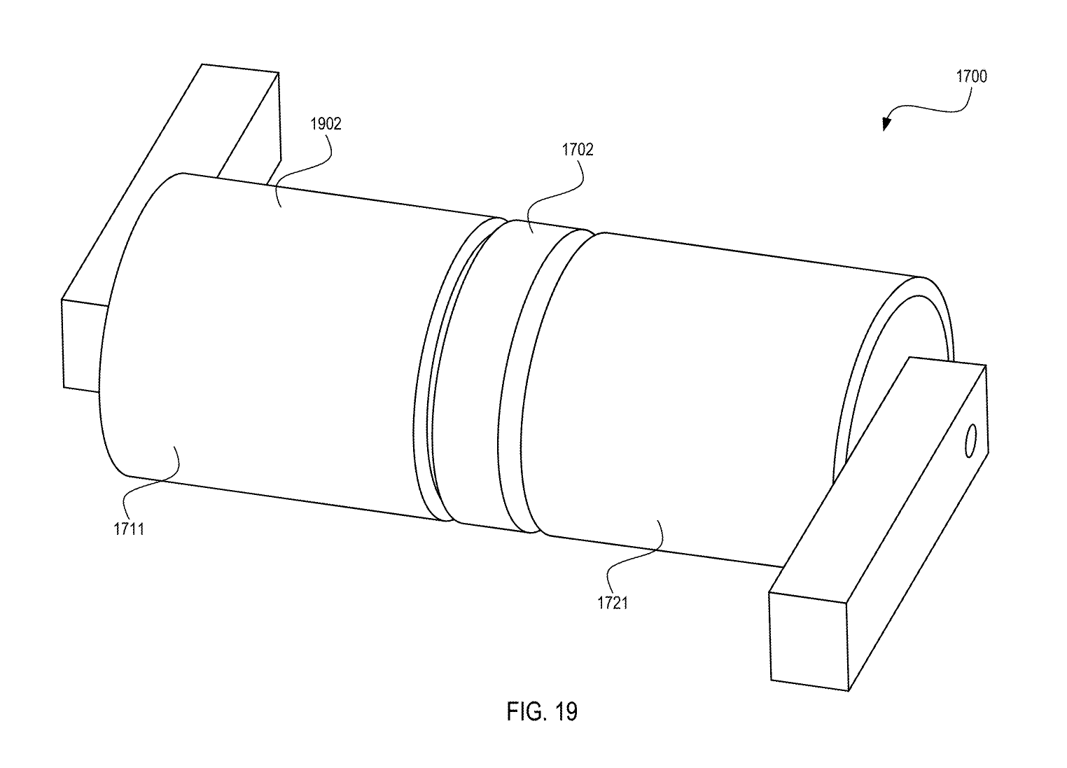

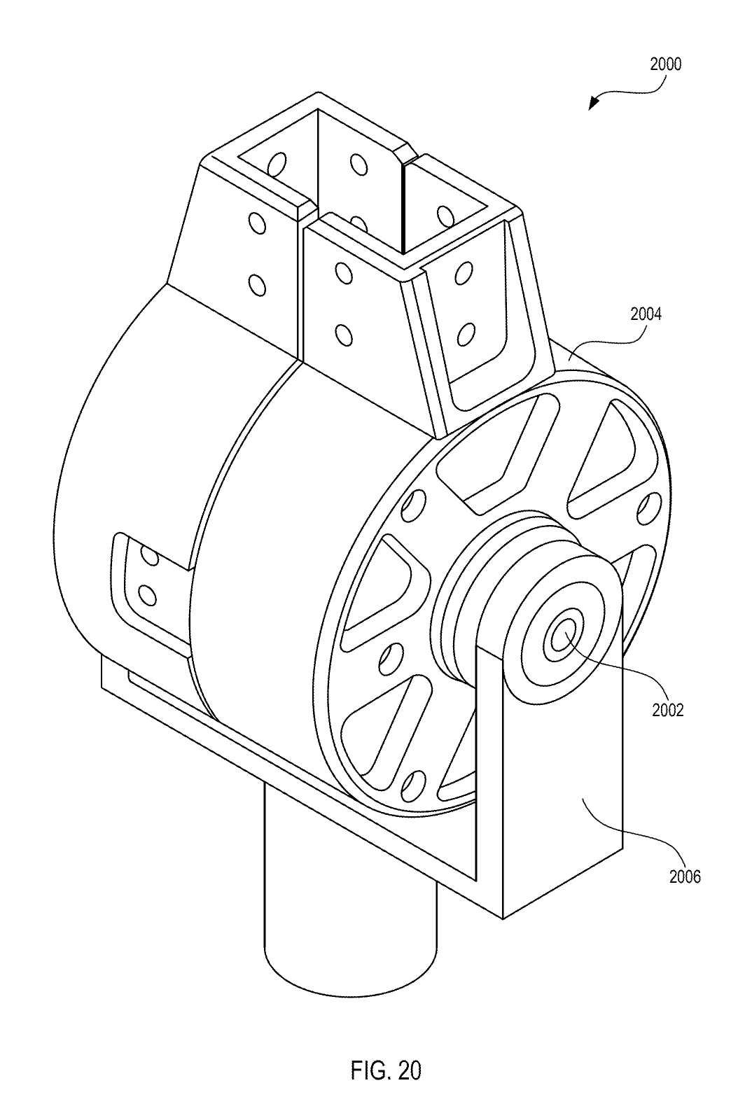

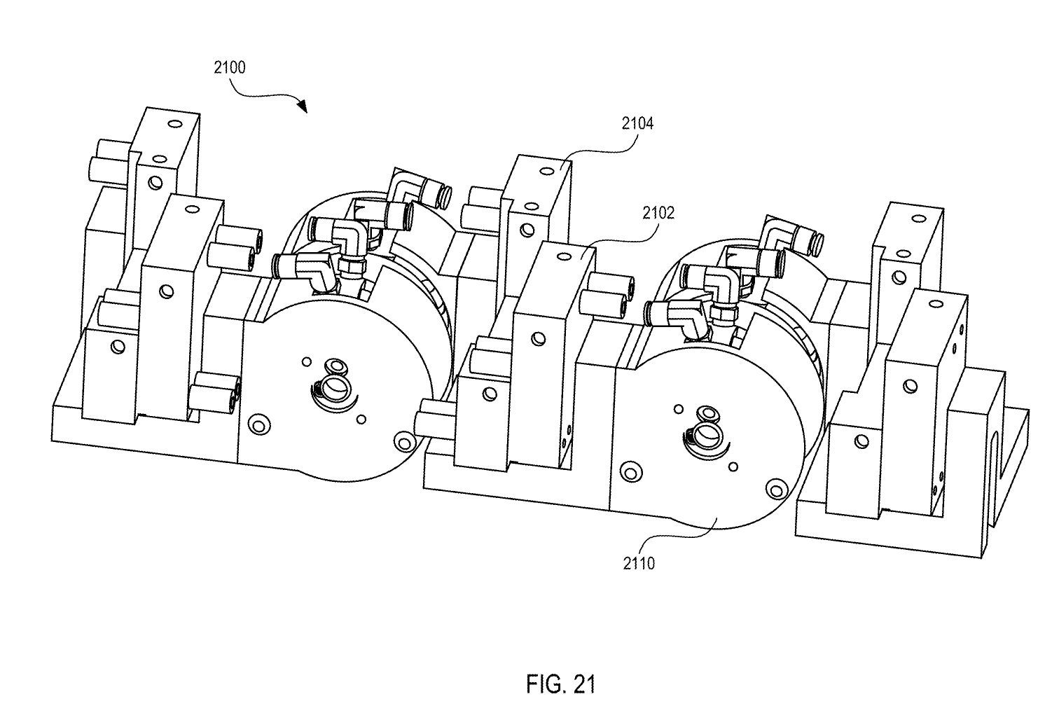

FIG. 19 illustrates a perspective view of a stacked hydraulic rotary actuator 1700 with connecting plate 1702. The axles 1711, 1721 may have a series of attachment mechanisms for the piston axle linkages. In the illustrated embodiment, a set of receiving holes 1902 may allow pegs of the piston axle linkages to be inserted through the axles 1711, 1721. The pegs may be welded to the axle or may be attached using fasteners such as bolts.

FIG. 20 illustrates an embodiment of a stacked hydraulic rotary actuator 2000 with an internal axle 2002. Just as discussed with reference to the external axle of FIGS. 16-19, an internal axle 2002 of the stacked hydraulic rotary actuator 2000 may be used to increase the rotation or torque of a joint.

In the illustrated embodiment, stacked hydraulic rotary actuator 2000 with an internal axle 2002 has the porting and fixed connections to yield double the torque of a single actuator. In this embodiment the internal axle 2002 extends beyond the joint housing 2004, so that a link 2006 may be attached to the internal axle 2002. In some embodiments, the link 2006 and internal axle 2002 may be connected directly by screws, gear fittings, weld or other attachments. In some embodiments, the link 2006 may be attached to a fixed plate, or another joint.

FIGS. 21-25 illustrate an internal manifold (2102, 2104) with tee fittings. These internal tee fittings may replace the hoses controlling the joints 2110. In some embodiments, the internal manifold (2102, 2104) may replace all hoses except for an input hose from a tank and pump to the joint.

FIG. 21 illustrates a perspective view of a joint-manifold assembly 2100 with internal flow paths. Each joint 2110 may have two hoses that pass through the axis of rotation from one side of the joint to the other side of the joint in some embodiments. The hoses (not shown) through the centerline connect the joint actuators ports through the inner tee fittings of the internal manifold (2102, 2104). The internal manifold (2102, 2104) may increase the durability of an assembly over a hose connected assembly. The internal manifold (2102, 2104) also decreases the chance of the connecting fittings (e.g., hoses) being snagged, broken, or kinked.

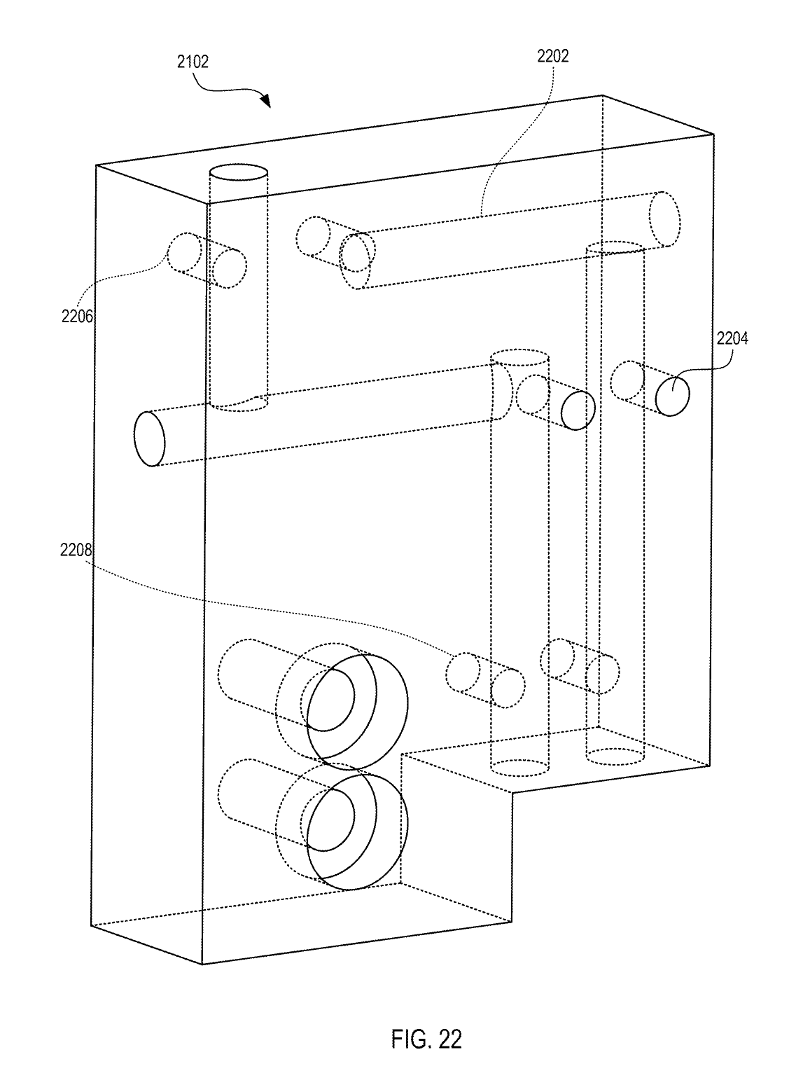

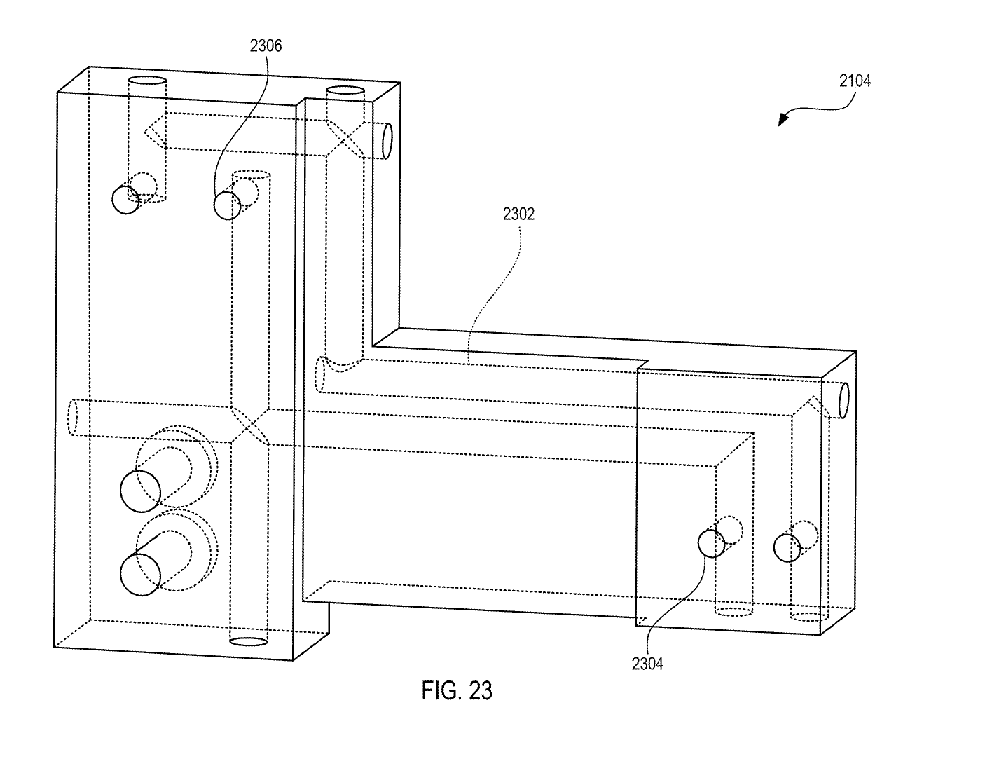

FIG. 22 illustrates a perspective view of a first manifold half 2102 with internal flow paths 2202. FIG. 23 illustrates a perspective view of a second manifold half 2104 with internal flow paths 2302. Each manifold half comprises a series of ports (e.g., 2204, 2206, 2208, 2304, 2306) and internal flow paths 2202, 2302. The first and second manifold halves 2102, 2104 may be paired to form a full manifold. The pairing forms internal tee fittings by connecting ports and forming combined flow paths. In some embodiments the manifold half 2104 may be mounted on a first side of a joint 2110 and manifold half 2102 may be mounted on second side of the same joint 2110 and fluid communication may transfer across the joint from hoses. The fluid communication across the joint may be to increase the either the degrees of rotation or the torque of a single actuator. In other embodiments, hoses may not transfer fluid across the joints and the fluid communication is completely contained inside the manifold to eliminate external hoses across the joint.

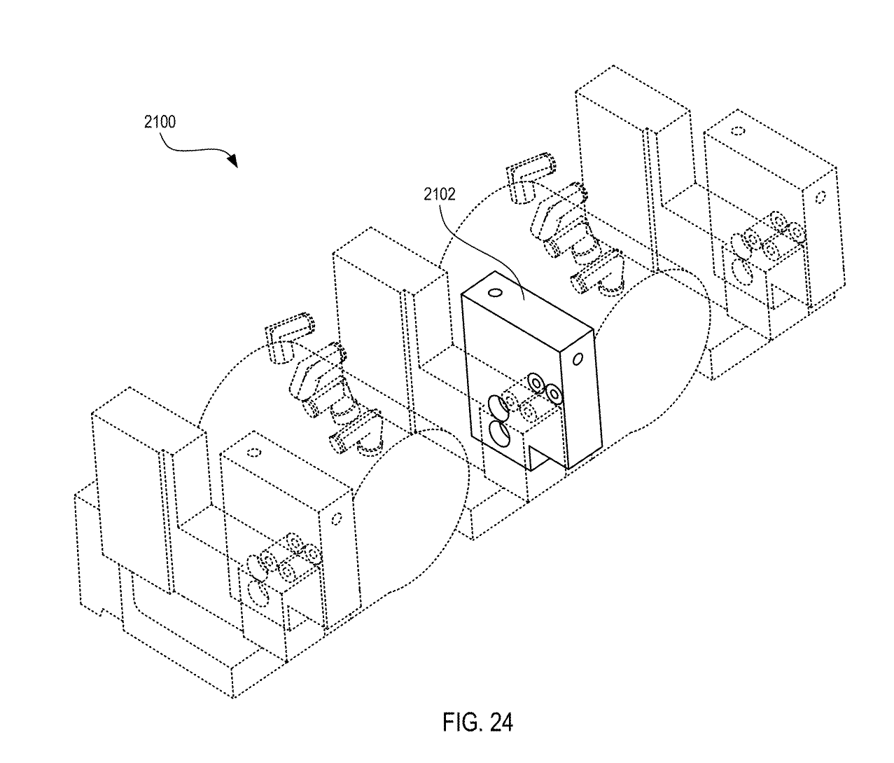

FIG. 24 illustrates the placement of the first manifold half 2102 in the joint-manifold assembly 2100. The first manifold half 2102 may facilitate fluid transfer among multiple joints and/or receive external fluid from a tank and pump. Different configurations may be achieved by fluidly coupling joints to some ports while plugging other ports.

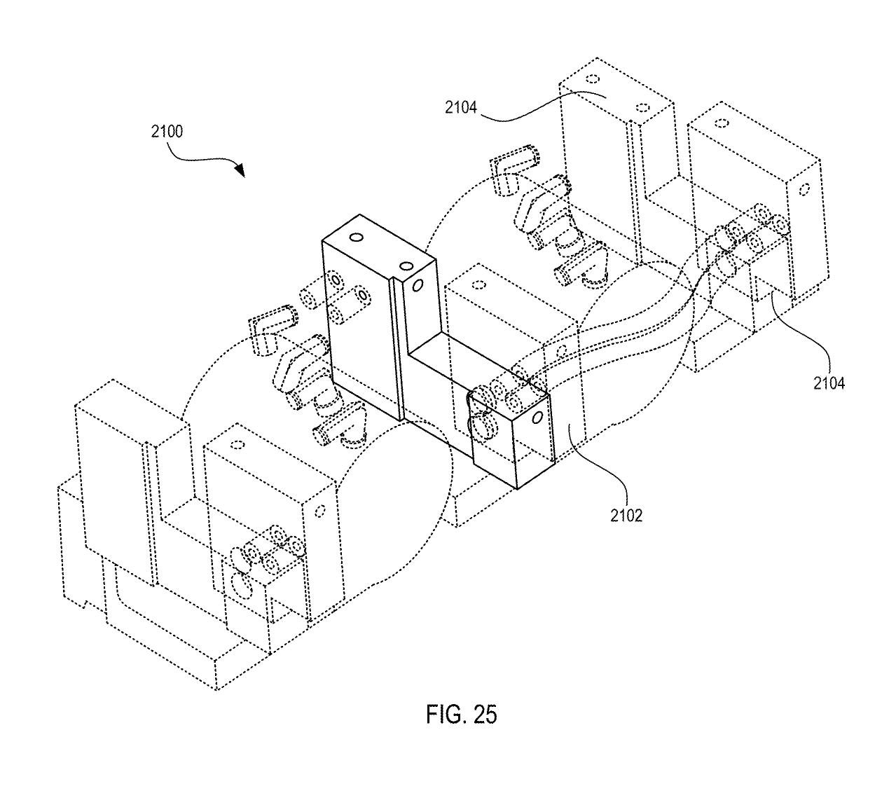

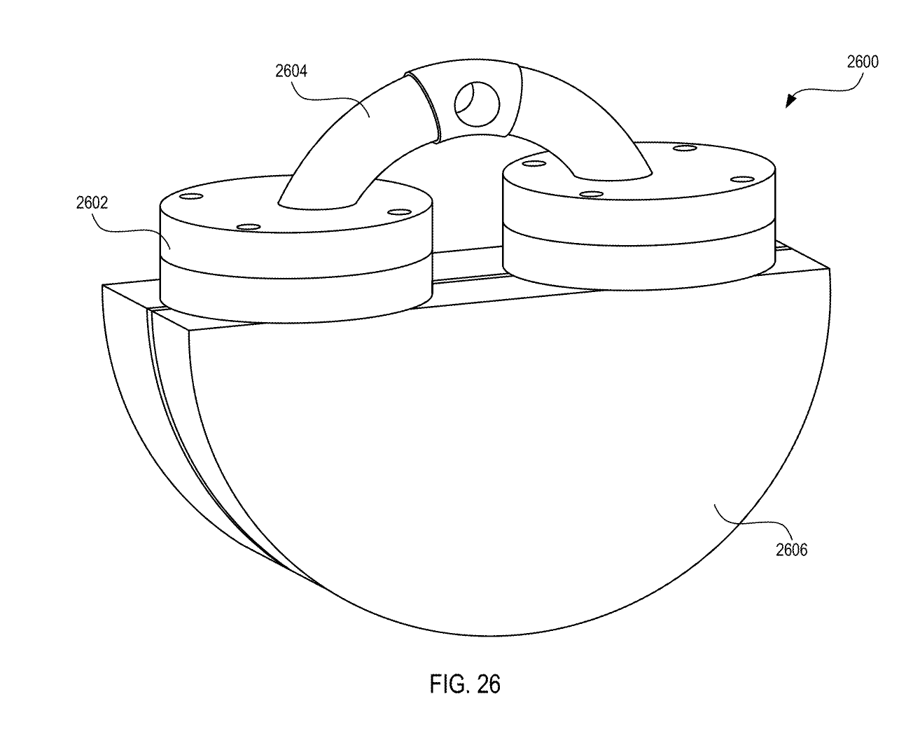

FIG. 25 illustrates the placement of the second manifold half 2104 in the joint-manifold assembly 2100. The second manifold half 2104 may facilitate fluid transfer between joint halves and/or receive external fluid from a tank and pump. Additionally, some ports of the second manifold half 2104 may couple to the first manifold half 2102 to facilitate fluid coupling between joints. Different configurations may be achieved by fluidly coupling joint halves to some ports while plugging other ports.

FIG. 26 illustrates a perspective view of an actuator 2600 with a static seal between the endcap 2602 and a cylinder, and a dynamic seal between the endcap 2602 and piston rod 2604. The static seal and the dynamic seal may prevent leaking. The cylinder (not shown in FIG. 26) is encompassed by an actuator housing 2606. Potential leakage points of the actuator 2600 are between connections (cylinder endcap connection) and around moving parts (piston rod 2604). The seals prevent leaking at these points.

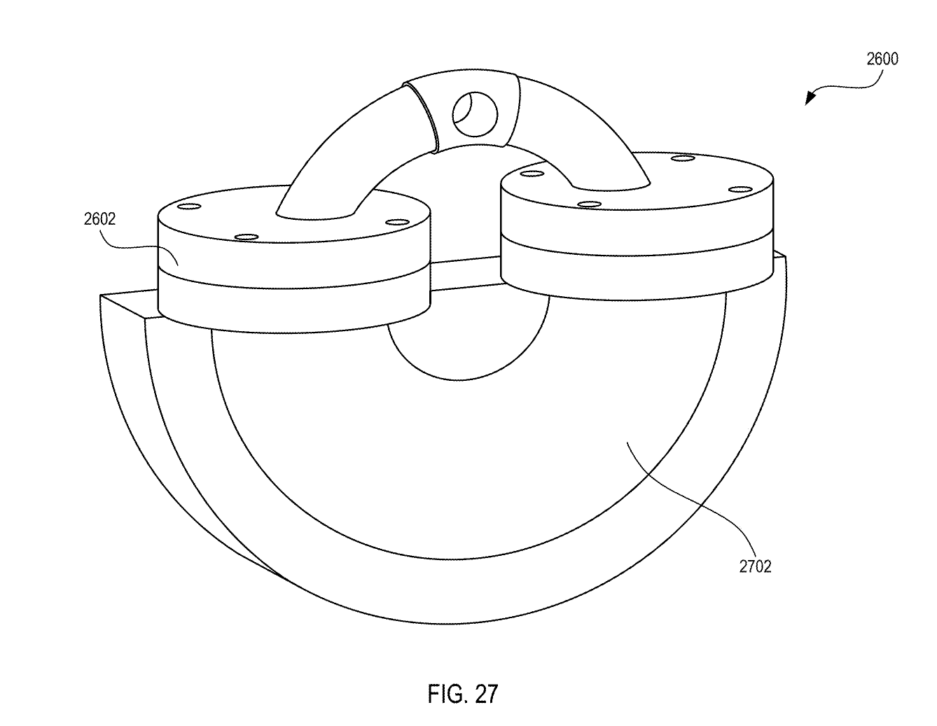

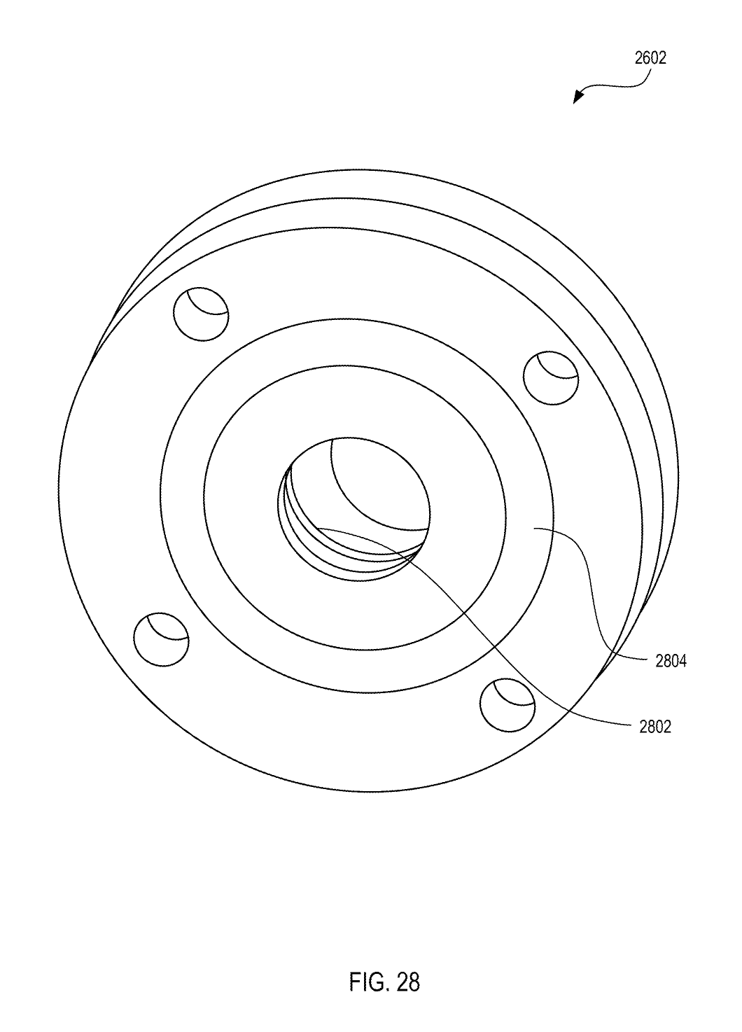

FIG. 27 illustrates the actuator 2600 of FIG. 26 with the cylinder 2702 exposed. The static seal is configured to interface with the cylinder 2702 and prevent leaking between the endcap 2602 and the cylinder 2702.

FIG. 28 illustrates an endcap 2602 with a static seal 2804 and dynamic seal 2802 integrated into the endcap 2602. As shown, the dynamic seal 2802 may be positioned within the aperture of the endcap 2602. The dynamic seal 2802 may fit snugly around a piston rod that extends through the aperture. The dynamic seal 2802 may be a material with small or negligible friction to facilitate piston rod movement such as Buna Nitrile O-rings.

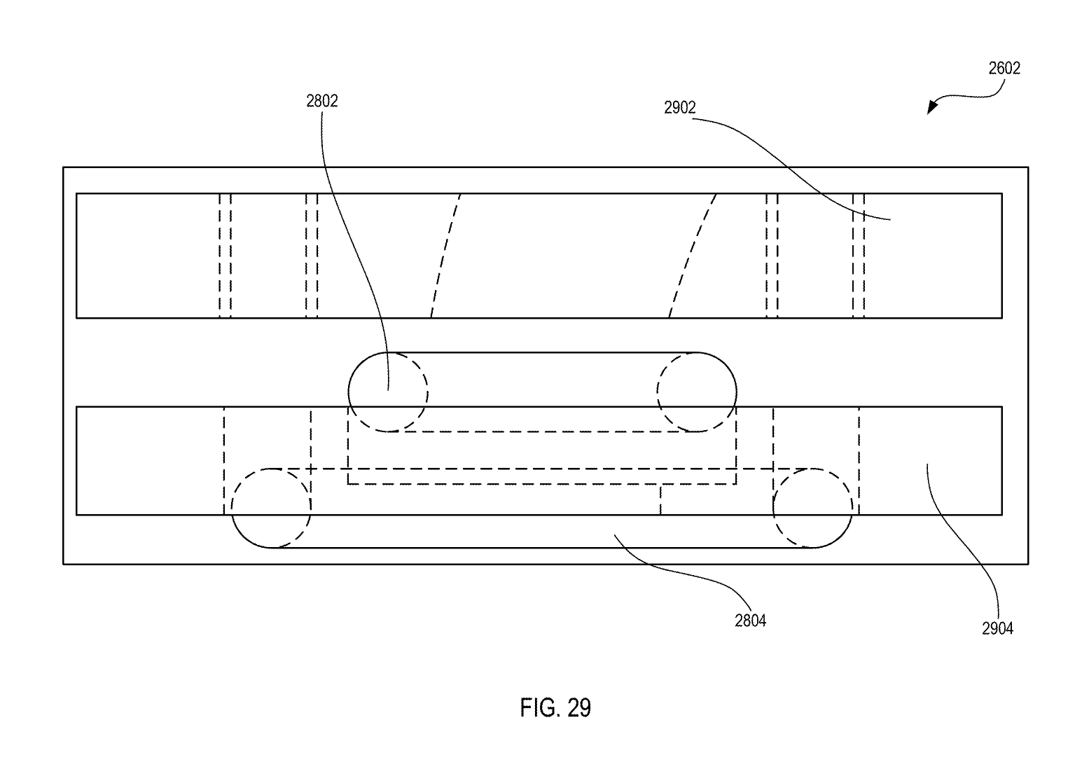

FIG. 29 illustrates a side exploded view of an endcap 2602. The endcap 2602 may be made of two halves, and the two halves may be attached to the cylinder and/or the actuator housing. For instance, the endcap 2602 may comprise a retainer 2902 and a plate 2904 integrated with seal grooves. The static seal 2804 may be placed in a seal groove on a first side of the plate 2904, and the dynamic seal 2802 may be placed in a second seal groove on a second side of the plate 2904. In some embodiments, the seals may be coupled to the plate 2904. In some embodiments, when the retainer 2902, plate 2904, and cylinder are coupled together, the coupling applies a force to maintain the position of the seals. For instance the retainer 2902 may be coupled to the plate 2904 to fasten the dynamic seal 2802.

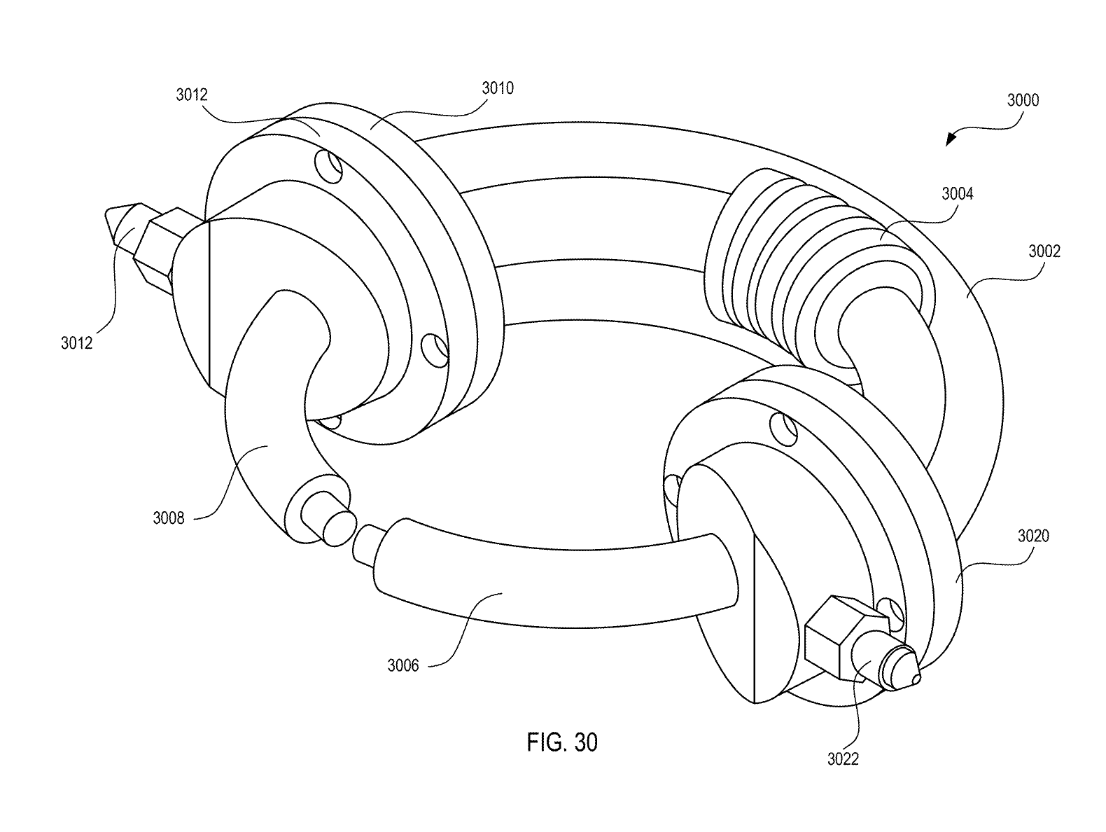

FIG. 30 illustrates a perspective view of a dual directional actuator 3000 with fluid ports 3012, 3022 and endcaps 3010, 3020 with integrated seals. The dual directional actuator 3000 may comprise a cylinder 3002, a piston 3004, piston rods 3006, 3008, and endcaps 3010, 3020. Fluid entering one of the ports may provide pressure that causes the piston 3004 to change position, thereby causing the piston rods 3006, 3008 to also actuate.

In some embodiments, the piston and piston rod may be assembled in four pieces. For example, the piston rods 3006, 3008 may have a mating end that is received by a receptacle in the piston 3004. The fourth piece may be a piston axle linkage (not shown) that couples the piston rods 3006, 3008. For instance, the piston linkage assembly 110 of FIG. 1 may be used. The endcaps 3010, 3020 may be secured to the actuator housing (not shown) by through holes in the endcaps. The actuator housing (such as 600 or 310) may have receiving threaded holes to attached endcaps 3010, 3020. Other attachment method such as welding may be used. An alignment tongue and groove may be used in some embodiments to maintain alignment of the piston rod hole through the endcap.

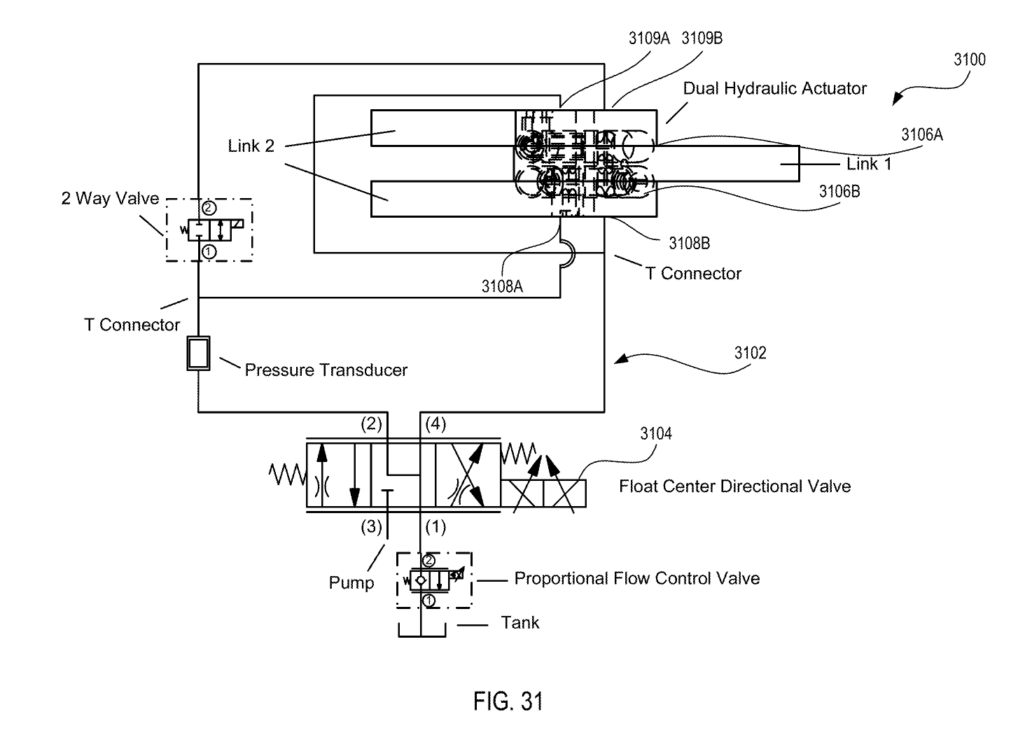

FIGS. 31-33 illustrate three embodiments where two actuators are connected in series or in parallel. Parallel fluidly connected actuators comprise two actuators connected so that the actuators rotate in the same direction to create additional torque. The additional torque is the torque of each actuator in parallel multiplied by the number of actuators in the hydraulic joint. Whereas, when rotary actuators are series fluidly connected, rotary actuators the actuators rotate in the opposite direction to create an additive degrees of rotation of each individual actuator in the hydraulic joint while maintaining the torque of an individual actuators.

FIG. 31 illustrates a hydraulic rotary joint 3100 with a fluid series control circuit 3102. In some embodiments, the fluid series control circuit 3102 uses a single Float Center Directional valve 3104 to control directional movement of the joint 3100. The rotary actuators 3106A, 31066 are ported in series with a T connection which connects port 3108A and port 3109B together in fluid communication with the directional valve. Likewise, Ports 3108B and 3109A are connected together so that the actuators apply work in the opposite direction with respect to a load on the joint links. This cross porting causes the actuators to rotate in opposite directions.

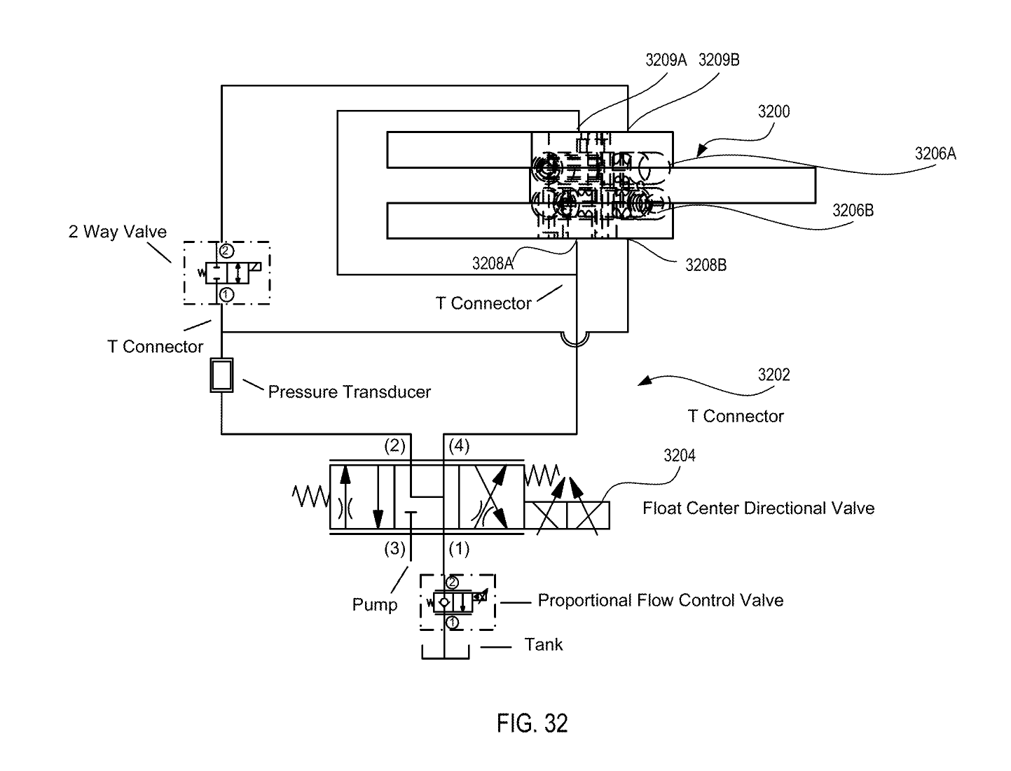

FIG. 32 illustrates a hydraulic rotary joint 3200 with a parallel fluid control circuit 3202. The parallel fluid control circuit may use a single Float Center Directional valve 3204 to control directional movement of the joint. The rotary actuators 3206A, 3206B are ported in parallel with a T connection connecting port 3208A and port 3209A together in fluid communication with the directional valve. Likewise, Ports 3208B and 3209B are connected together so that the actuators apply work in the same direction with respect to a load on the joint links. This porting configuration causes the actuators to rotate in same direction with the parallel porting connection.

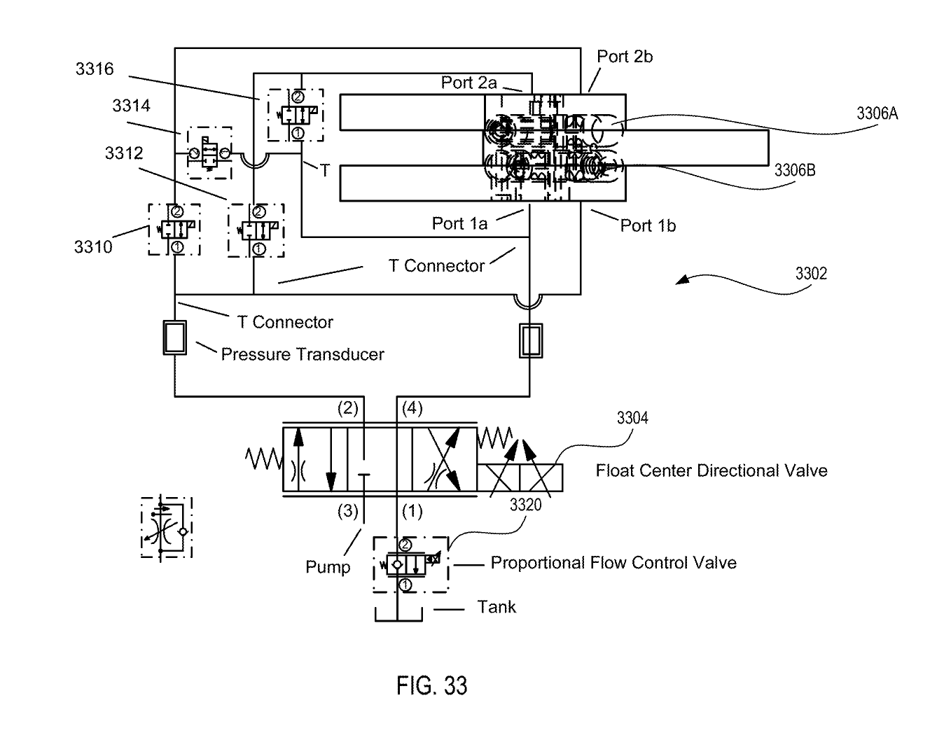

FIG. 33 illustrates a hydraulic circuit 3302 that enables electronically switching between parallel and series fluidly connected actuators. The embodiment shows four 2-way valves 3310, 3312, 3314, 3316 that can be energized to connect the ports in either the series or parallel configuration (similar to the series and parallel configurations of FIG. 31 and FIG. 32, respectively). This allows greater flexibility in the degrees of rotation and torque of a single hydraulic rotary actuator.

While a mechanical mechanism may be used to secure the actuators together, some embodiments enable controlling the actuators with either double the torque or double the rotation by simply energizing a normally closed 2-way directional valves as indicated as described below. The 2-way directional valves' 3310, 3312, 3314, 3316 on and off states determine whether the torque or degrees of rotation are doubled, in an embodiment with two actuators 3306A, 3306B, and the float center directional valve 3304 determines the direction of movement. These actuators may be switched rapidly between series and parallel configurations to enable lifting heavy objects and still maintain the maximum degrees of rotation. For instance, in some embodiments, normal switching times of these valves is 50 ms.

The hydraulic circuit 3302 allows switching between Parallel and Series fluidically connected actuators is for a general design wherein the joint can be electronically controlled to operate in either parallel or series connection. For a normally closed 2-way directional valve, if the a first valve 3310 is off, a second valve 3312 is on, a third valve 3314 is on, and a fourth valve 3316 is off, the hydraulic circuit 3302 is connected in series. For a normally closed 2-way directional valve, if the a first valve 3310 is on, a second valve 3312 is off, a third valve 3314 is off, and a fourth valve 3316 is on, the hydraulic circuit 3302 is connected in parallel.

Additionally, in some embodiments the float center valve 3304 may have proportional control and together with flow control 3320 facilitates collaborative hydraulic control. The float center valve 3304 in the center position (de-energized) enables fluid to flow freely between the actuators in either series or parallel connections when a 2-way blocking valve is open. This enables back drivability of a robotic joint. However, the weight of gravity from a load on the joint may make the robotic joint fall. Proportional controller may be used to control the float center valve 3304 to counteract the force of gravity on a hydraulic joint and still allow back drivability. Back drivability allows a human operator to cause movement of the robotic joint by pushing.

For example, a force torque sensor on the joint may be used to determine the difference of a force on the joint due to gravity of a load and a force exerted by a human pushing force. The proportional float center directional valve 3304 can be energized to allow a fluid pressure to counter the force of gravity on the hydraulic joint, and a robotic arm can self balance the joint and still allow back drivability of the joint by a human operator. The back drivability allows a human operator to manually manipulate the hydraulic joint or robotic arm, and the proportional control of the float center directional valve 3304 cancels the force of gravity. The force of gravity may be calculated from known positions and weights of loads on the hydraulic joint or robotic arm or it may be measured from the force torque sensors in the hydraulic joints.

### EXAMPLES

The following is a list of example embodiments that fall within the scope of the disclosure. In order to avoid complexity in providing the disclosure, not all of the examples listed below are separately and explicitly disclosed as having been contemplated herein as combinable with all of the others of the examples listed below and other embodiments disclosed hereinabove. Unless one of ordinary skill in the art would understand that these examples listed below, and the above disclosed embodiments, are not combinable, it is contemplated within the scope of the disclosure that such examples and embodiments are combinable.

### Example 1

A dual directional actuator comprising: an actuation cylinder configured in an arc shape; a piston disposed within the actuation cylinder; a first piston rod coupled to a first end of the piston and a second piston rod coupled to a second end of the piston, wherein the first and second piston rods are configured in an arc shape to enable the first and second piston rods to selectively rotate into the actuation cylinder; a piston linkage assembly configured to couple the first piston rod and the second piston rod together, wherein the coupled piston, first and second piston rods, and piston linkage assembly form a closed piston loop; an axle transverse to the closed piston loop and extending through a center of the closed piston loop; a bridge coupling the piston linkage assembly and the axle; a plurality of fluid media ports configured to provide power to the actuator by channeling a fluid medium into and out of the plurality of fluid media ports; wherein the first and second piston rods rotate in a first direction in response to the fluid medium entering a first fluid port and exiting from a second fluid port, and the first and second piston rods rotate in a second and opposite direction in response to the fluid medium entering the second fluid port and exiting from the first fluid port, wherein the first and second piston rods rotate the piston linkage assembly, and the bridge transfers rotational movement to the axle.

### Example 2

The dual directional actuator of example 1, further comprising at least one additional dual directional actuator, the two dual directional actuators fluidly coupled to one another in a parallel configuration with the two dual directional actuators capable of rotation in the same direction to increase the torque of the two coupled actuators when considered collectively.

### Example 3

The dual directional actuator of example 2, wherein the piston linkage assembly is further configured to couple piston rods of each additional dual directional actuator to couple the two dual directional actuators fluidly in parallel.

### Example 4

The dual directional actuator of example 3, wherein the piston linkage assembly is a single piece with mating features for each piston rod of each dual directional actuator.

### Example 5

The dual directional actuator of example 1, further comprising at least one additional dual directional actuator, the two dual directional actuators coupled to one another in a fluid series cross port configuration with the two dual directional actuators capable of rotation in the opposite direction to increase the degrees of rotation of the two coupled actuators.

### Example 6

The dual directional actuator of example 1, further comprising a second bridge coupling the piston linkage assembly and the axle, wherein the first and second bridges are coupled to opposing sides of the piston linkage assembly.

### Example 7

The dual directional actuator of example 1, further comprising housing encompassing the piston, the first and second piston rods, and the piston linkage assembly, the housing configured to provide access to the plurality of fluid media ports.

### Example 8

The dual directional actuator of example 1, wherein the bridge, the piston linkage assembly, and the axle are fixedly attached to each other.

### Example 9

The dual directional actuator of example 1, wherein the bridge, the piston linkage assembly, and the axle are a single unified structure.

### Example 10

A robotic joint comprising: a plurality of dual directional actuators, each dual directional actuator comprising: an actuation cylinder, and a piston assembly partially disposed within each of one or more actuation cylinders, wherein each dual directional actuator of the plurality of actuators is configured to operate by moving the piston assembly and by pumping a fluid through the actuation cylinder; one or more piston assembly linkage assemblies coupled to the piston assembly; an axle extending through each dual directional actuator; and one or more bridges coupling the one or more piston assembly linkage assemblies to the axle so that the piston assembly of each of the plurality of dual directional actuators and the axle rotate dependently.

### Example 11

The robotic joint of example 10, wherein the dual directional actuators further comprise a second actuation cylinder and a second piston assembly, and wherein the one or more piston assembly linkage assemblies couple the two piston assemblies of each dual directional actuator.

### Example 12

The robotic joint of example 10, wherein there is one piston assembly linkage assembly for each dual directional actuator.

### Example 13

The robotic joint of example 10, further comprising a housing to encompass the plurality of dual directional actuators, the housing comprising a first half to encompass a first set of dual directional actuators and a second half to encompass a second set of dual directional actuators, wherein the first and the second halves are separately attached to the robotic joint to fully encompass the plurality of dual directional actuators.

### Example 14

The robotic joint of example 13, further comprising a lock nut to secure the housing to the axle, and a flange bearing between the lock nut and the housing to allow the axle to rotate independent of the housing.

### Example 15

The robotic joint of example 10, wherein the plurality of dual directional actuators are coupled to one another in a parallel configuration with the plurality of dual directional actuators capable of rotation in the same direction to increase the torque applied to the axle when considered collectively.

### Example 16

The robotic joint of example 10, wherein the plurality of dual directional actuators are coupled to one another in a series cross port configuration with the plurality of dual directional actuators capable of rotation in differing directions to rotate the robotic joint further than one of the plurality of dual directional actuators can individually.

### Example 17

The robotic joint of example 10, further comprising an encoder shaft extending through a center of the axle to measure rotation of the robotic joint.

### Example 18

The robotic joint of example 17, further comprising an encoder shaft bearing to allow the housing to rotate independent of the encoder shaft.

### Example 19

A hydraulic rotary joint comprising: a dual directional actuator comprising: an actuation cylinder configured in an arc shape, and a piston assembly partially disposed within the actuation cylinder, wherein the dual directional actuator is configured to operate by moving the piston assembly by pumping a fluid through the actuation cylinder; an external axle surrounding the dual directional actuator; and an axle link coupled to an edge of the external axle and the piston assembly and configured to enable the piston assembly and the external axle to rotate dependently.

### Example 20

The hydraulic rotary joint of example 19, further comprising an encoder shaft extending through an axis of rotation of the external axle, wherein the axle link is further coupled to the encoder shaft.

### Example 21

The hydraulic rotary joint of example 19, further comprising a bearing between the dual directional actuator and the external axle.

### Example 22

The hydraulic rotary joint of example 19, further comprising a second axle link coupled to a second edge of the external axle and the piston assembly.

### Example 23

The hydraulic rotary joint of example 19, wherein the axle link comprises a plate.

### Example 24

The hydraulic rotary joint of example 23, wherein the plate forms a slot to provide access to fluid ports on the dual directional actuator.

### Example 25

The hydraulic rotary joint of example 23, wherein the plate forms a semi-circle to provide access to fluid ports on the dual directional actuator.

### Example 26

The hydraulic rotary joint of example 19, wherein the axle link comprises mating features to couple to other hydraulic rotary joints.

### Example 27

The hydraulic rotary joint of example 26, wherein the external axle of the hydraulic rotary joint is coupled to a second external axle of two other orthogonal hydraulic rotary joints to form a ball joint.

### Example 28

A robotic joint comprising: a plurality of dual directional actuators, each dual directional actuator comprising a piston assembly, wherein each of the plurality of dual directional actuators are configured to rotate one of the piston assembly; an external axle surrounding the plurality of dual directional actuators; an axle link coupled to an interior surface of the external axle and at least one piston assembly and configured to enable the piston assembly and the external axle to rotate dependently; and an external link coupled to the external axle.

### Example 29

The robotic joint of example 28, further comprising tee fittings connecting the plurality of dual directional actuators to one another.

### Example 30

The robotic joint of example 28, further comprising a connecting plate to couple the dual directional actuators to another dual directional actuator.

### Example 31

The robotic joint of example 28, wherein the axle link comprises: a drive pin extending through at least one piston assembly; and a bridge coupling the drive pin to the external axle.

### Example 32

The robotic joint of example 28, wherein the axle link is a plate encompassed by the external axle.

### Example 33

The robotic joint of example 28, further comprising manifolds with internal flow paths, wherein the plurality of dual directional actuators comprise fluid ports are fluidly coupled to each other by the internal flow paths of the manifolds.

### Example 34

The robotic joint of example 28, further comprising an actuator housing, and a bearing between an actuator housing and the external axle to allow independent rotation of the axle and the actuator housing.

### Example 35

The robotic joint of example 34, wherein the external link connects the robotic joint to other joints, wherein the actuator housing and the external link are fixedly attached to rotate dependently.

### Example 36

The robotic joint of example 34, wherein the external link connects the robotic joint to other joints, wherein the external axle and the external link are fixedly attached to rotate dependently.

### Example 37

The robotic joint of example 34, further comprising a coupling plate connecting actuator housings and the external axle together.

### Example 38

A dual directional actuator comprising a piston and a piston rod. Wherein, the piston rod is connected to both sides of a piston.

### Example 39

A dual directional actuator comprising a torus actuator with bearings between the axle and a first actuator housing to allow independent rotation of the first actuator housing and axle.

### Example 40

The dual directional actuator of example 38, further comprising hydraulic cylinders, a second actuator housing, and a first and a second joint housing. Wherein the first actuator housing is attached to the first joint housing and the second actuator housing is attached to the second joint housing. Wherein the first and the second actuator housings contains the hydraulic cylinders.

### Example 41

A hydraulic rotary joint comprising a torus actuator comprising an axle and an orthogonal joint attached to the axle of a torus actuator. Wherein the axle rotates the orthogonal joint.

### Example 42

The hydraulic rotary joint of example 41, wherein the axle is an internal axle.

### Example 43

The hydraulic rotary joint of example 41, wherein the axle is an external axle.

### Example 44

A hydraulic rotary joint comprising a first actuator cylinder encased in an actuator housing. Wherein the actuator housing is fixedly attached to a half hydraulic joint housing to cause dependent rotation of the joint housing and actuator housing. The hydraulic rotary joint further comprising an axle and a bearing between the axle and the actuator housing.

### Example 45

The hydraulic rotary joint of example 44, further comprising a second actuator cylinder encased in a second actuator housing attached to a second half hydraulic joint housing. Wherein, a second bearing is between the axle and the second actuator housing.

### Example 46

A hydraulic rotary joint comprising an axle and an encoder shaft through the axle. The encoder shaft fixedly attached to a first joint housing half and attached with bearings to a second joint housing half to allow a second joint housing half to rotate independently of encoder shaft.

### Example 47

A hydraulic rotary joint comprising an actuator housing, an external axle, bearings between the external axle and the actuator housing to enable independent rotation. The hydraulic rotary joint further comprising a piston and an attachment fixedly coupling the piston and axle to enable dependent rotation.

### Example 48

A method of conformal grasping of a robotic gripper. The method comprising changing a number of links between robotic joints involved in the conformal grasping. The links between parallel fingers not involved in the conformal grasping can be caused to align in parallel close proximity to control finger span involved in the conformal grasping.

### Example 49

A proportional float center valve for lift assist of collaborative robots, which compensates for the effects of robot arm weight and load due to gravity.

### Example 50

A hydraulic circuit comprising a set of 2-way valves for electronically switching between a series and parallel fluidly connected hydraulic joint to either increase the torque or degrees of rotation. The 2-way valves control port flow direction of the hydraulic joint with a single directional valve.

### Example 51

A hydraulic rotary joint comprising a first pair of actuators and one or more secondary actuators. The hydraulic rotary joint further comprising a coupling plate connecting the first pair of actuators and the secondary actuators to enable increased torque or degrees of rotation greater than a first pair of actuators.

### Example 52

A hydraulic joint with internal fluid manifolds to reduce hoses used when compared with a traditional hydraulic joint.

It will be obvious to those having skill in the art that many changes may be made to the details of the above-described embodiments without departing from the underlying principles of the invention. The scope of the present invention should, therefore, be determined only by the following claims.

1. A dual directional actuator comprising:
an actuation cylinder configured in an arc shape;
a piston disposed within the actuation cylinder;
a first piston rod coupled to a first end of the piston and a second piston rod coupled to a second end of the piston, wherein the first and second piston rods are configured in an arc shape to enable the first and second piston rods to selectively rotate into the actuation cylinder;
a piston linkage assembly configured to couple the first piston rod and the second piston rod together, wherein the coupled piston, first and second piston rods, and piston linkage assembly form a closed piston loop;
an axle transverse to the closed piston loop and extending through a center of the closed piston loop;
a bridge coupling the piston linkage assembly and the axle;
a plurality of fluid media ports configured to provide power to the actuator by channeling a fluid medium into and out of the plurality of fluid media ports;
wherein the first and second piston rods rotate in a first direction in response to the fluid medium entering a first fluid port and exiting from a second fluid port, and the first and second piston rods rotate in a second and opposite direction in response to the fluid medium entering the second fluid port and exiting from the first fluid port,
wherein the first and second piston rods rotate the piston linkage assembly, and the bridge transfers rotational movement to the axle.

2. The dual directional actuator of claim 1, further comprising at least one additional dual directional actuator, the two dual directional actuators fluidly coupled to one another in a parallel configuration with the two dual directional actuators capable of rotation in the same direction to increase the torque of the two coupled actuators when considered collectively.

3. The dual directional actuator of claim 2, wherein the piston linkage assembly is further configured to couple piston rods of each additional dual directional actuator to couple the two dual directional actuators fluidly in parallel.

4. The dual directional actuator of claim 3, wherein the piston linkage assembly is a single piece with mating features for each piston rod of each dual directional actuator.

5. The dual directional actuator of claim 1, further comprising at least one additional dual directional actuator, the two dual directional actuators coupled to one another in a fluid series cross port configuration with the two dual directional actuators capable of rotation in the opposite direction to increase the degrees of rotation of the two coupled actuators.

6. The dual directional actuator of claim 1, further comprising a second bridge coupling the piston linkage assembly and the axle, wherein the first and second bridges are coupled to opposing sides of the piston linkage assembly.

7. The dual directional actuator of claim 1, further comprising housing encompassing the piston, the first and second piston rods, and the piston linkage assembly, the housing configured to provide access to the plurality of fluid media ports.

8. The dual directional actuator of claim 1, wherein the bridge, the piston linkage assembly, and the axle are fixedly attached to each other.

9. The dual directional actuator of claim 1, wherein the bridge, the piston linkage assembly, and the axle are a single unified structure.

10. A robotic joint comprising:
a plurality of dual directional actuators, each dual directional actuator comprising:
an actuation cylinder, and
a piston assembly partially disposed within each of one or more actuation cylinders, wherein each dual directional actuator of the plurality of actuators is configured to operate by moving the piston assembly and by pumping a fluid through the actuation cylinder;
one or more piston assembly linkage assemblies coupled to the piston assembly;
an axle extending through each dual directional actuator; and
one or more bridges coupling the one or more piston assembly linkage assemblies to the axle so that the piston assembly of each of the plurality of dual directional actuators and the axle rotate dependently.

11. The robotic joint of claim 10, wherein the dual directional actuators further comprise a second actuation cylinder and a second piston assembly, and wherein the one or more piston assembly linkage assemblies couple the two piston assemblies of each dual directional actuator.

12. The robotic joint of claim 10, wherein there is one piston assembly linkage assembly for each dual directional actuator.

13. The robotic joint of claim 10, further comprising a housing to encompass the plurality of dual directional actuators, the housing comprising a first half to encompass a first set of dual directional actuators and a second half to encompass a second set of dual directional actuators, wherein the first and the second halves are separately attached to the robotic joint to fully encompass the plurality of dual directional actuators.

14. The robotic joint of claim 13, further comprising a lock nut to secure the housing to the axle, and a flange bearing between the lock nut and the housing to allow the axle to rotate independent of the housing.

15. The robotic joint of claim 10, wherein the plurality of dual directional actuators are coupled to one another in a parallel configuration with the plurality of dual directional actuators capable of rotation in the same direction to increase the torque applied to the axle when considered collectively.

16. The robotic joint of claim 10, wherein the plurality of dual directional actuators are coupled to one another in a series cross port configuration with the plurality of dual directional actuators capable of rotation in differing directions to rotate the robotic joint further than one of the plurality of dual directional actuators can individually.

17. The robotic joint of claim 10, further comprising an encoder shaft extending through a center of the axle to measure rotation of the robotic joint.

18. The robotic joint of claim 17, further comprising an encoder shaft bearing to allow the housing to rotate independent of the encoder shaft.

19. A hydraulic rotary joint comprising:
a dual directional actuator comprising:
an actuation cylinder configured in an arc shape, and
a piston assembly partially disposed within the actuation cylinder, wherein the dual directional actuator is configured to operate by moving the piston assembly by pumping a fluid through the actuation cylinder;
an external axle surrounding the dual directional actuator; and
an axle link coupled to an edge of the external axle and the piston assembly and configured to enable the piston assembly and the external axle to rotate dependently.

20. The hydraulic rotary joint of claim 19, further comprising an encoder shaft extending through an axis of rotation of the external axle, wherein the axle link is further coupled to the encoder shaft.

21. The hydraulic rotary joint of claim 19, further comprising a bearing between the dual directional actuator and the external axle.

22. The hydraulic rotary joint of claim 19, further comprising a second axle link coupled to a second edge of the external axle and the piston assembly.

23. The hydraulic rotary joint of claim 19, wherein the axle link comprises a plate.

24. The hydraulic rotary joint of claim 23, wherein the plate forms a slot to provide access to fluid ports on the dual directional actuator.

25. The hydraulic rotary joint of claim 23, wherein the plate forms a semi-circle to provide access to fluid ports on the dual directional actuator.

26. The hydraulic rotary joint of claim 19, wherein the axle link comprises mating features to couple to other hydraulic rotary joints.

27. The hydraulic rotary joint of claim 26, wherein the external axle of the hydraulic rotary joint is coupled to a second external axle of an orthogonal hydraulic rotary joints to form a ball joint.

28. A robotic joint comprising:
a plurality of dual directional actuators, each dual directional actuator comprising a piston assembly, wherein each of the plurality of dual directional actuators are configured to rotate one of the piston assembly;
an external axle surrounding the plurality of dual directional actuators;
an axle link coupled to an interior surface of the external axle and at least one piston assembly and configured to enable the piston assembly and the external axle to rotate dependently; and
an external link coupled to the external axle.

29. The robotic joint of claim 28, further comprising tee fittings connecting the plurality of dual directional actuators to one another.

30. The robotic joint of claim 28, further comprising a connecting plate to couple the robotic joint to another robotic joint.

31. The robotic joint of claim 28, wherein the axle link comprises:
a drive pin extending through at least one piston assembly; and
a bridge coupling the drive pin to the external axle.

32. The robotic joint of claim 28, wherein the axle link is a plate encompassed by the external axle.

33. The robotic joint of claim 28, further comprising manifolds with internal flow paths, wherein the plurality of dual directional actuators comprise fluid ports are fluidly coupled to each other by the internal flow paths of the manifolds.

34. The robotic joint of claim 28, further comprising an actuator housing, and a bearing between an actuator housing and the external axle to allow independent rotation of the axle and the actuator housing.

35. The robotic joint of claim 34, wherein the external link connects the robotic joint to other actuators, wherein the actuator housing and the external link are fixedly attached to rotate dependently.

36. The robotic joint of claim 34, wherein the external link connects the robotic joint to other joints, wherein the external axle and the external link are fixedly attached to rotate dependently.

37. The robotic joint of claim 34, further comprising a coupling plate connecting actuator housings and the external axle together.
